(19) United States
(12) Patent Application Publication
(10) Pub. No.: US 2026/0050774 A1
(43) Pub. Date: Feb. 19, 2026

(54) GROUND TRUTH DETERMINATION FOR NETWORK DETECTIONS ON TEXT-BASED PROTOCOLS BY LLM

(71) Applicant: Palo Alto Networks, Inc., Santa Clara, CA (US)

(72) Inventors: Matthew W. Tennis, Santa Clara, CA (US); Yuwen Dai, Santa Clara, CA (US); Zhibin Zhang, Santa Clara, CA (US); Chao Lei, Sunnyvale, CA (US); Christian Elihu Navarrete Discua, San Jose, CA (US); Xiaosa Yang, San Jose, CA (US); Zhemin Su, San Jose, CA (US)

(21) Appl. No.: 18/809,137

(22) Filed: Aug. 19, 2024

(51) Int. Cl. G06N 3/0475; G06F 21/55

(52) U.S. Cl. CPC G06N 3/0475; G06F 21/554; G06F 2221/034

(57) ABSTRACT

The present application discloses a method, system, and computer system for enriching a ground truth of a machine learning-based detection using a large language model (LLM). The method includes: (a) obtaining a machine learning (ML)-based prediction for a security detection, (b) prompting a large language model (LLM) for an LLM-based prediction for the security detection based at least in part on a set of examples of malware, and (c) determining a ground truth of the ML-based prediction for the security detection based at least in part on a response from the LLM.

### BACKGROUND OF THE INVENTION

The rapid advancement and ubiquity of internet-based services have brought about an unprecedented increase in network traffic. Alongside the benefits of this increased connectivity, there has been a corresponding rise in the volume and sophistication of cyber threats. Malicious activities such as hacking, phishing, Distributed Denial of Service (DDoS) attacks, and the deployment of malware are becoming more frequent and complex. Traditional security measures, including signature-based detection and rule-based systems, often fall short in identifying and mitigating these evolving threats in real-time.

Machine Learning (ML) has emerged as a powerful tool in the realm of cybersecurity, offering the ability to detect anomalies and predict malicious activities based on patterns within network traffic data. However, ML models are not infallible and may produce false positives or false negatives due to limitations in training data or model generalization. ML models additionally fail to contextualize classifications. For example, ML models generally just indicate a prediction of whether the sample is malicious or benign without providing any insight into the rationale for the predicted classification.

### BRIEF DESCRIPTION OF THE DRAWINGS

Various embodiments of the invention are disclosed in the following detailed description and the accompanying drawings.

FIG. 1 is a block diagram of an environment for determining a ground truth classification of samples according to various embodiments.

FIG. 2 is a block diagram of a system for determining a ground truth classification of samples according to various embodiments.

FIGS. 3A-3H are examples of an LLM-based prediction for a sample according to various embodiments.

FIG. 4A is an example of a prompt provided to an LLM for establishing a context for the LLM in connection with obtaining an LLM-based prediction for a sample according to various embodiments.

FIG. 4B is an example of at least part of prompt provided to an LLM for instructing the LLM to return an LLM-based prediction in a predefined format according to various embodiments.

FIG. 4C is an example of at least part of prompt provided to an LLM for providing a set of examples of known sample classifications according to various embodiments.

FIG. 4D-4F are examples of a prompt provided to an LLM for requesting an LLM-based classification and a corresponding LLM-based prediction returned in response to the prompt according to various embodiments.

FIG. 4G is an example of a prompt provided to an LLM for establishing a context for the LLM in connection with obtaining an LLM-based prediction for a sample according to various embodiments.

FIG. 5 is a flow diagram of a method for establishing a ground truth for a sample classification according to various embodiments.

FIG. 6 is a flow diagram of a method for using an LLM-based prediction in connection with establishing a ground truth for a sample classification according to various embodiments.

FIG. 7 is a flow diagram of a method for verifying an ML model-based prediction according to various embodiments.

FIG. 8 is a flow diagram of a method for establishing a ground truth for a sample classification according to various embodiments.

FIG. 9 is a flow diagram of a method for identifying samples for which an LLM is to be used to verify an ML model-based prediction according to various embodiments.

FIG. 10 is a flow diagram of a method for verifying an ML model-based prediction according to various embodiments.

FIG. 11 is a flow diagram of a method for obtaining an LLM-based prediction according to various embodiments.

FIG. 12 is a flow diagram of a method for configuring an LLM context according to various embodiments.

FIG. 13 is a flow diagram of a method for verifying an ML model-based prediction according to various embodiments.

FIG. 14 is a flow diagram of a method for determining a prompt to obtain an LLM-based prediction according to various embodiments.

FIG. 15 is a flow diagram of a method for using the ground truth for a sample classification to update an ML model according to various embodiments.

FIG. 16 is a flow diagram of a method for determining ground truth for a sample classification according to various embodiments.

FIG. 17 is a flow diagram of a method for causing the LLM to be retaught according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, a security entity may be a network node (e.g., a device) that enforces one or more security policies with respect to information such as network traffic, files, etc. As an example, a security entity may be a firewall. As another example, a security entity may be implemented as a router, a switch, a DNS resolver, a computer, a tablet, a laptop, a smartphone, etc. Various other devices may be implemented as a security entity. As another example, a security may be implemented as an application running on a device, such as an anti-malware application.

As used herein, malware may refer to an application that engages in behaviors, whether clandestinely or not (and whether illegal or not), of which a user does not approve/would not approve if fully informed. Examples of malware include trojans, viruses, rootkits, spyware, hacking tools, keyloggers, etc. One example of malware is a desktop application that collects and reports to a remote server the end user's location (but does not provide the user with location-based services, such as a mapping service). Another example of malware is a malicious Android Application Package .apk (APK) file that appears to an end user to be a free game, but stealthily sends SMS premium messages (e.g., costing $10 each), running up the end user's phone bill. Another example of malware is an Apple IOS flashlight application that stealthily collects the user's contacts and sends those contacts to a spammer. Other forms of malware can also be detected/thwarted using the techniques described herein (e.g., ransomware). Further, while malware signatures are described herein as being generated for malicious applications, techniques described herein can also be used in various embodiments to generate profiles for other kinds of applications (e.g., adware profiles, goodware profiles, etc.).

As used herein, a feature may include a measurable property or characteristic manifested in input data, which may be raw data. As an example, a feature may be a set of one or more relationships manifested in the input data. As another example, a feature may be a set of one or more relationships between text and a product or application, between text and compliance of a product/application with one or more protocols, etc.

As used herein, a machine learning (ML) model may include a model trained according to a machine learning technique and/or a deep learning technique. Examples of machine learning processes that can be implemented in connection with training the model include random forest, linear regression, support vector machine, naive Bayes, logistic regression, K-nearest neighbors, decision trees, gradient boosted decision trees, K-means clustering, hierarchical clustering, density-based spatial clustering of applications with noise (DBSCAN) clustering, principal component analysis, etc.

According to various embodiments, the system for detecting a malicious file is implemented by one or more servers. The one or more servers may provide a service for one or more customers and/or security entities. For example, the one or more servers detect malicious files or determine/assess whether files are malicious, and provide an indication of whether a file is malicious to the one or more customers and/or security entities. The one or more servers provide to a security entity the indication that a file is malicious in response to a determination that the file is malicious and/or in connection with an updated to a mapping of files to indications of whether the files of malicious (e.g., an update to a blacklist comprising identifier(s) associated with a malicious file(s)). As another example, the one or more servers determine whether a file is malicious in response to a request from a customer or security for an assessment of whether a file is malicious, and the one or more servers provide a result of such a determination.

Ground truth validation for AI/ML network security detections is a difficult task. In related art, AI/ML detections typically occur when our traditional pattern-based detections are unable to detect the threat. This means that checking if an AI/ML detection is right or wrong usually cannot be easily validated with patterns, especially against deep learning models. The scale of our detections for a security service (e.g., a detection across one or more customers or tenants) routinely reaches hundreds of millions per month and vastly outweighs organization's ability to investigate with automation and manual efforts. The deficiencies of ML models in predicting sample classifications (e.g., predicting whether a sample is malicious or benign) necessitates the development of a more robust system that can enhance the accuracy and reliability of threat detection.

Related art solutions may include resorting to sampling traffic to try and extrapolate the ground truth, but that is not a satisfactory result for true ground truth metrics.

Large Language Models (LLMs), like those based on the GPT architecture, have demonstrated remarkable capabilities in understanding and generating human-like text based on contextual information. These models can analyze large datasets, comprehend nuanced patterns, and provide insights that might be missed by traditional ML approaches.

Various embodiments leverage the strengths of LLMs to provide a security service capable of distinguishing between malicious and benign traffic samples. This service not only enhances the detection of threats but also validates the predictions made by conventional ML models, thereby reducing the likelihood of erroneous classifications (e.g., reducing or eliminating false positives or false negatives).

In some embodiments, the LLM acts as an additional layer of verification for the predictions made by existing ML models. By cross-referencing the ML model's output (e.g., the ML-based prediction) with its own analysis, the LLM can confirm or contest the initial classification, thus enhancing the overall accuracy of the threat detection system. The system can use the ML-based prediction and/or the LLM-based prediction in connection with determining a ground truth for the sample (e.g., a ground truth sample classification).

When a security entity such as a firewall intercepts a sample of network traffic, this sample is forwarded to the security service that leverages a Large Language Model (LLM) for classification. The traffic sample typically includes various attributes such as source and destination IP addresses, port numbers, packet payloads, traffic patterns, and timestamps.

The LLM-based classification process can include one or more of:
Feature Extraction: The raw network traffic sample is preprocessed to extract relevant features. These features may include metadata and statistical data that can be fed into the LLM. Examples of extracted features might be protocol type, frequency of packets, average packet size, and patterns in the payload content
Contextual Information Integration: Additional context, such as historical data about similar traffic samples, threat intelligence feeds, and known behavioral patterns of benign and malicious traffic, is integrated into the feature set. This contextual information enriches the data provided to the LLM, allowing it to make more informed predictions, and
Prompting the LLM: The preprocessed data, along with the contextual information, is formatted into a structured prompt. This prompt is designed to provide the LLM with a comprehensive view of the traffic sample and its associated context. An example of such a prompt may include:
   Analyze the following network traffic sample and provide a classification (malicious or benign) based on the features and context provided:
      Source IP: 192.168.1.1
      Destination IP: 10.0.0.1
      Source Port: 443
      Destination Port: 8080
      Protocol: HTTPS
      Packet Payload: [Base64 encoded payload data]
      Historical Context: Similar traffic patterns have been observed in previous DDoS attacks
      Known Threat Intelligence: For example, an indication that the destination IP or source IP is associated with a known malicious server
Classification Generation: Upon receiving the prompt, the LLM processes the provided information. Leveraging its extensive training on diverse textual data and its ability to recognize complex patterns, the LLM analyzes the features and context to generate a predicted classification. The LLM might output a classification such as “malicious” or “benign,” along with a confidence score and/or a brief explanation of its reasoning.

According to various embodiments, to optimize the performance and accuracy of the LLM, the context provided to it can be carefully configured. The configuration of the LLM context may include:
Contextual Prompt Engineering: Crafting prompts that effectively communicate the relevant features and background information to the LLM. This includes using clear and concise language, organizing data logically, and emphasizing critical information
Incorporating Domain-Specific Knowledge: Feeding the LLM with domain-specific knowledge and threat intelligence. This can be achieved by incorporating structured data such as threat databases, behavioral signatures, and historical attack patterns into the prompts.
Dynamic Context Updates: Continuously updating the context based on new threat intelligence and evolving attack vectors. This ensures that the LLM remains current and capable of recognizing the latest malicious activities
Feedback Loop: Implementing a feedback mechanism where the LLM's classifications are periodically reviewed and validated by cybersecurity experts. The feedback can be used to fine-tune the prompts and improve the LLM's performance over time.

By meticulously configuring the context and providing well-structured prompts, the security service can maximize the effectiveness of the LLM in classifying network traffic samples, thereby enhancing the overall security posture of the network.

Various embodiments provide a method, system, and computer system for enriching a ground truth of a machine learning-based detection using a large language model (LLM). The method includes: (a) obtaining a machine learning (ML)-based prediction for a security detection, (b) prompting a large language model (LLM) for an LLM-based prediction for the security detection based at least in part on a set of examples of malware, and (c) determining a ground truth of the ML-based prediction for the security detection based at least in part on a response from the LLM.

According to various embodiments, to efficiently manage the volume of network traffic data and reduce the number of queries made to the LLM, clustering techniques can be employed. Clustering involves grouping similar traffic samples based on their features so that a representative sample from each cluster can be analyzed, minimizing the need to individually query every sample. The system can cluster a set of samples into a cluster and select a representative sample from among the set of samples within the cluster. The system can then use the representative sample in connection with querying an LLM for an LLM-based prediction, and can use the LLM-based prediction as a proxy sample classification for the cluster (e.g., for each sample within the cluster).

In some embodiments, the clustering of a set of samples includes:
Feature Extraction: As with the individual sample analysis, features are extracted from each network traffic sample. These features are used to identify similarities and differences among the samples.
Clustering Algorithm: A suitable clustering algorithm, such as K-means, DBSCAN (Density-Based Spatial Clustering of Applications with Noise), or hierarchical clustering, is applied to the feature set. The choice of algorithm depends on the nature of the data and the specific requirements of the clustering task.
Cluster Formation: The result of the clustering algorithm is a set of clusters, where each cluster contains traffic samples that share similar characteristics. The clustering process reduces the overall number of distinct groups that need to be analyzed.
Representative Sample Selection. The system identifies/selects a sample to serve as a representative sample of the cluster and for which an LLM-based prediction may be used as a proxy for sample classification of other samples within the cluster. As an example, the system may implement a centroid or medoid sample selection. For each cluster, a representative sample is selected. This could be the centroid (the average of all samples in the cluster) in the case of K-means, or the medoid (the sample that is most centrally located within the cluster) for other algorithms. The representative sample is chosen to best represent the characteristics of the entire cluster.
Representative Sample Analysis: The selected representative sample from each cluster is then used as the input for the LLM query. This approach assumes that the classification of the representative sample can serve as a proxy for all the samples within that cluster. For example, the system may do a validation/verification that the identified sample is in fact representative of all (or most) samples within the cluster.
LLM Query: The representative sample is formatted into a structured prompt, incorporating any relevant contextual information. The prompt is designed to provide the LLM with comprehensive data for accurate classification.
Classification (the LLM-based prediction): The LLM processes the prompt and provides a classification for the representative sample. This classification is then applied to all the samples within the same cluster, assuming they share similar characteristics and behavior.

Clustering a set of samples before implementing an LLM to perform sample classification has several advantages including reduced computational load, improved efficiency, scalability, and accuracy measurement. For example, by clustering similar samples and querying the LLM with only the representative samples, the overall number of LLM queries is significantly reduced, leading to lower computational and resource demands. As another example, clustering allows for faster processing and classification of large volumes of network traffic, enhancing the responsiveness of the security service. As another example, the implementation of a sample clustering technique makes the security service more scalable, capable of handling higher volumes of traffic without a proportional increase in computational overhead. In some embodiments, while reducing the number of queries, the use of representative samples from well-defined clusters ensures that the accuracy of threat detection and classification is maintained, as similar samples are likely to share the same classification.

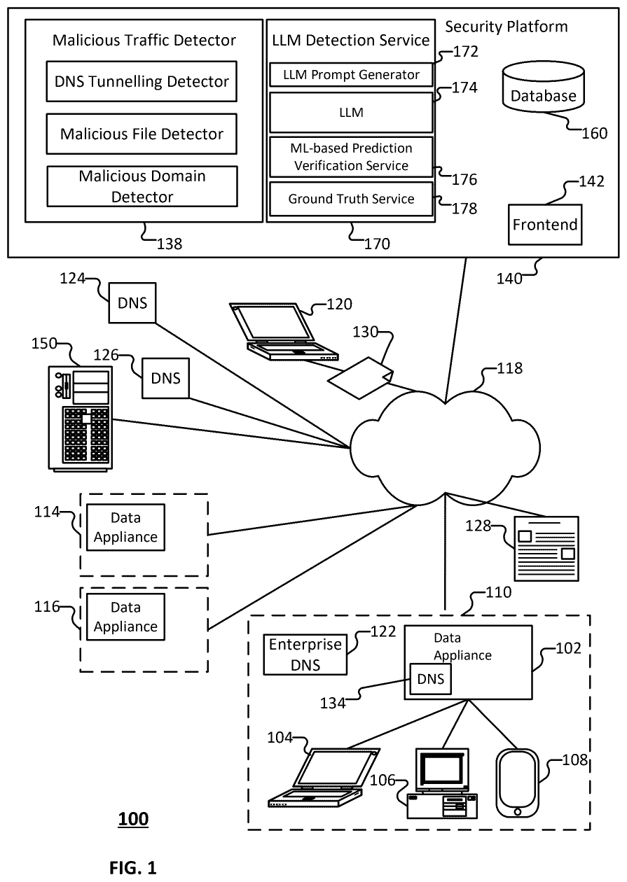

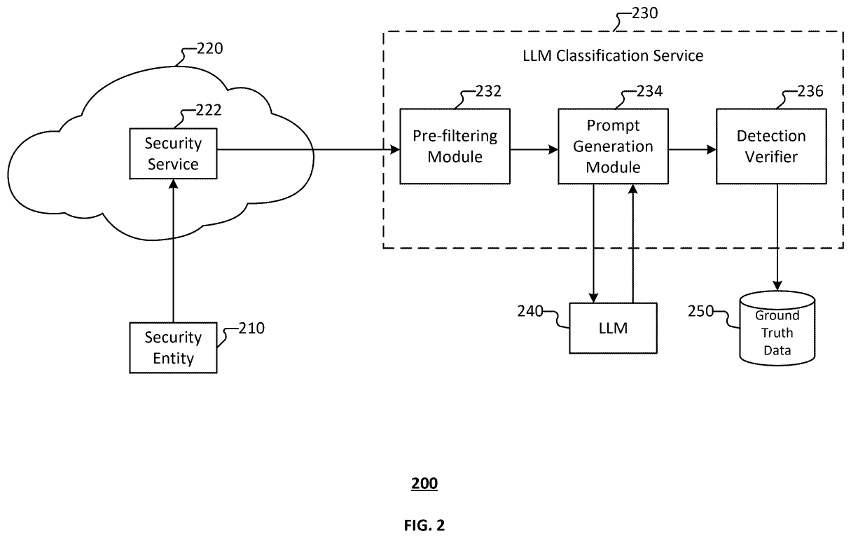

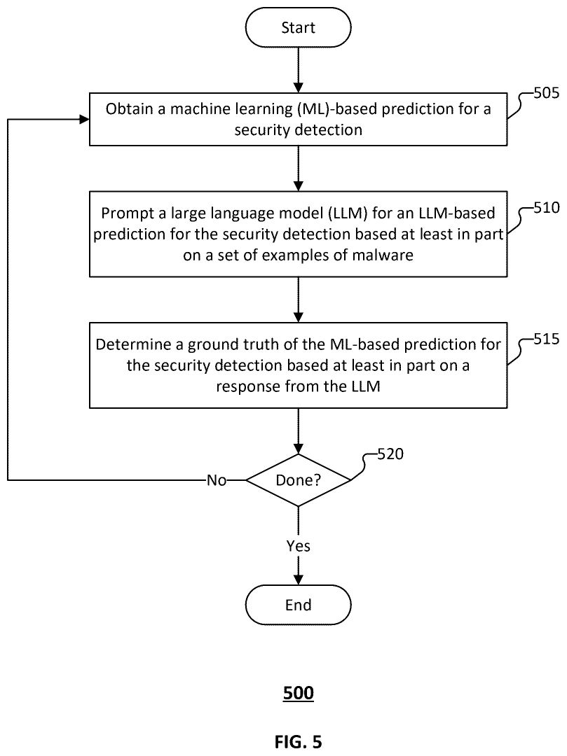

FIG. 1 is a block diagram of an environment for determining a ground truth classification of samples according to various embodiments. In some embodiments, system 100 is implemented at least in part by system 200 of FIG. 2. System 100 may implement one or more of processes 500-1700 of FIGS. 5-17.

Various embodiments implement the use of an LLM-based prediction of a sample classification in connection with validating/verifying a sample classification using other classification techniques or otherwise in connection with determining a ground truth sample classification. For example, the system can define an LLM context, teach the LLM using a set of predefined examples and/or hints, and then query the LLM for the LLM-based prediction. The system uses the combination of sample classifications from the LLM and other classification techniques (e.g., an ML analysis and ML-based prediction, a set of heuristics, a set of rules, or other types of classifiers) to determine the ground truth sample classification.

In the example shown, client devices 104-108 are a laptop computer, a desktop computer, and a tablet (respectively) present in an enterprise network 110 (belonging to the “Acme Company”). Data appliance 102 is configured to enforce policies (e.g., a security policy, a network traffic handling policy, etc.) regarding communications between client devices, such as client devices 104 and 106, and nodes outside of enterprise network 110 (e.g., reachable via external network 118). Examples of such policies include policies governing traffic shaping, quality of service, and routing of traffic. Other examples of policies include security policies such as ones requiring the scanning for threats in incoming (and/or outgoing) email attachments, website content, inputs to application portals (e.g., web interfaces), files exchanged through instant messaging programs, and/or other file transfers. Other examples of policies include security policies (or other traffic monitoring policies) that selectively block traffic, such as traffic to malicious domains, DNS hijacked domains, or stockpiled domains, or such as traffic for certain applications (e.g., SaaS applications). In some embodiments, data appliance 102 is also configured to enforce policies with respect to traffic that stays within (or from coming into) enterprise network 110.

In some embodiments, data appliance 102 is a security entity, such as a firewall (e.g., an application firewall, a next generation firewall, etc.). An enterprise network (e.g., a network for a tenant serviced by security platform 140) may comprise a set of data appliances 102 (e.g., a set of remote network nodes).

Firewalls typically deny or permit network transmission based on a set of rules. These sets of rules are often referred to as policies (e.g., network policies, network security policies, security policies, etc.). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall rules or firewall policies, which can be triggered based on various criteria, such as are described herein). A firewall can also filter local network (e.g., intranet) traffic by similarly applying a set of rules or policies.

Security entities or other devices (e.g., security appliances, security gateways, security services, and/or other security devices) can include various security functions (e.g., firewall, anti-malware, intrusion prevention/detection, Data Loss Prevention (DLP), and/or other security functions), networking functions (e.g., routing, Quality of Service (QoS), workload balancing of network related resources, and/or other networking functions), and/or other functions. For example, routing functions can be based on source information (e.g., IP address and port), destination information (e.g., IP address and port), and protocol information.

A basic packet filtering firewall filters network communication traffic by inspecting individual packets transmitted over a network (e.g., packet filtering firewalls or first generation firewalls, which are stateless packet filtering firewalls). Stateless packet filtering firewalls typically inspect the individual packets themselves and apply rules based on the inspected packets (e.g., using a combination of a packet's source and destination address information, protocol information, and a port number).

Application firewalls can also perform application layer filtering (e.g., application layer filtering firewalls or second generation firewalls, which work on the application level of the TCP/IP stack). Application layer filtering firewalls or application firewalls can generally identify certain applications and protocols (e.g., web browsing using HyperText Transfer Protocol (HTTP), a Domain Name System (DNS) request, a file transfer using File Transfer Protocol (FTP), and various other types of applications and other protocols, such as Telnet, DHCP, TCP, UDP, and TFTP (GSS)). For example, application firewalls can block unauthorized protocols that attempt to communicate over a standard port (e.g., an unauthorized/out of policy protocol attempting to sneak through by using a non-standard port for that protocol can generally be identified using application firewalls).

Stateful firewalls can also perform state-based packet inspection in which each packet is examined within the context of a series of packets associated with that network transmission's flow of packets. This firewall technique is generally referred to as a stateful packet inspection as it maintains records of all connections passing through the firewall and is able to determine whether a packet is the start of a new connection, a part of an existing connection, or is an invalid packet. For example, the state of a connection can itself be one of the criteria that triggers a rule within a policy.

Advanced or next generation firewalls can perform stateless and stateful packet filtering and application layer filtering as discussed above. Next generation firewalls can also perform additional firewall techniques. For example, certain newer firewalls sometimes referred to as advanced or next generation firewalls can also identify users and content (e.g., next generation firewalls). In particular, certain next generation firewalls are expanding the list of applications that these firewalls can automatically identify to thousands of applications. Examples of such next generation firewalls are commercially available from Palo Alto Networks, Inc. (e.g., Palo Alto Networks' PA Series firewalls). For example, Palo Alto Networks' next generation firewalls enable enterprises to identify and control applications, users, and content—not just ports, IP addresses, and packets—using various identification technologies, such as the following: APP-ID for accurate application identification, User-ID for user identification (e.g., by user or user group), and Content-ID for real-time content scanning (e.g., controlling web surfing and limiting data and file transfers). These identification technologies allow enterprises to securely enable application usage using business-relevant concepts, instead of following the traditional approach offered by traditional port-blocking firewalls. Also, special purpose hardware for next generation firewalls (implemented, for example, as dedicated appliances) generally provide higher performance levels for application inspection than software executed on general purpose hardware (e.g., such as security appliances provided by Palo Alto Networks, Inc., which use dedicated, function specific processing that is tightly integrated with a single-pass software engine to maximize network throughput while minimizing latency).

Advanced or next generation firewalls can also be implemented using virtualized firewalls. Examples of such next generation firewalls are commercially available from Palo Alto Networks, Inc. (e.g., Palo Alto Networks' VM Series firewalls, which support various commercial virtualized environments, including, for example, VMware® ESXi™ and NSX™ Citrix® Netscaler SDX™, KVM/OpenStack (Centos/RHEL, Ubuntu®), and Amazon Web Services (AWS)). For example, virtualized firewalls can support similar or the exact same next-generation firewall and advanced threat prevention features available in physical form factor appliances, allowing enterprises to safely enable applications flowing into, and across their private, public, and hybrid cloud computing environments. Automation features such as VM monitoring, dynamic address groups, and a REST-based API allow enterprises to proactively monitor VM changes dynamically feeding that context into security policies, thereby eliminating the policy lag that may occur when VMs change.

Techniques described herein can be used in conjunction with a variety of platforms (e.g., desktops, mobile devices, gaming platforms, embedded systems, etc.) and/or a variety of types of applications (e.g., Android .apk files, iOS applications, Windows PE files, Adobe Acrobat PDF files, Microsoft Windows PE installers, etc.). In the example environment shown in FIG. 1, client devices 104-108 are a laptop computer, a desktop computer, and a tablet (respectively) present in an enterprise network 110. Client device 120 is a laptop computer present outside of enterprise network 110.

Data appliance 102 can be configured to work in cooperation with remote security platform 140. Security platform 140 can provide a variety of services, including training/re-training a machine learning model/classifier or other classifiers, validating classification techniques (e.g., evaluating an efficacy of a particular classifier/ML model), querying an LLM for an LLM-based prediction (e.g., an LLM-based sample classification), generating and providing an LLM prompt to configure a context and/or teach the LLM in connection with classifying a sample, pre-filtering samples to be classified via the LLM, post-filtering or validating the LLM-based prediction, determining a ground truth sample classification for one or more samples, mediating traffic to an application service (e.g., to provide access to the application service behind an enterprise network or authentication service), or various other security services for network traffic, such as real-time or contemporaneous classifications, or offline classifications. The various other security services may include securing a code base, classifying domains (e.g., predicting whether a domain is a DNS hijacked domain, etc.), classifying network traffic, providing a mapping of signatures to certain domains (e.g., domains for which a predicted likelihood that the domain is a DNS hijacked domain exceeds a predefined likelihood threshold, etc. a mapping of domains to domain data (e.g., domain certificates, pDNS data, active DNS data, WHOIS data, etc.), performing static and dynamic analysis on malware samples, monitoring new domains (e.g., detecting new domains for which a certificate is issued/generated), assessing maliciousness of domains, determining whether a domain associated with a traffic sample is (or is likely to be) a DNS hijacked domain, providing a list of signatures of known exploits (e.g., malicious input strings, malicious files, malicious domains, etc.) to data appliances, such as data appliance 102 as part of a subscription, detecting exploits such as malicious input strings, malicious files, or malicious domains (e.g., an on-demand detection, or periodical-based updates to a mapping of domains to indications of whether the domains are malicious or benign), providing a likelihood that a domain is malicious (e.g., a parked domain, a DNS hijacked domain) or benign (e.g., an unparked domain), providing/updating a whitelist of input strings, files, or domains deemed to be benign, providing/updating input strings, files, or domains deemed to be malicious, identifying malicious input strings, detecting malicious input strings, detecting malicious files, predicting whether input strings, files, or domains are malicious, providing an indication that an input string, file, or domain is malicious (or benign), simulating DNS hijacking attacks/campaigns (e.g., generating synthetic DNS hijacking records), and training classifiers (e.g., training machine learning models, such as to be used to provide inline detection of DNS hijacked domains, or offline detection of DNS hijacked domains), providing a load balancing of application traffic across a set of application servers configured (e.g., assigned/allocated to handle the application traffic).

In some embodiments, security platform 140 is deployed as a cloud service. For example, security platform 140 may be implemented by one or more servers and may comprise one or more clusters of worker nodes (e.g., virtual machines).

In some embodiments, security platform 140 (e.g., malicious traffic detector 138) classifies the network traffic, files, or domains in response to receiving a network traffic sample or according to a predefined schedule. For example, security platform 140 can perform the classification as the endpoint or network entity (e.g., a firewall or data appliance 102) detects traffic for a new domain, traffic to/from a suspicious domain, a new file, etc. In various embodiments, results of analysis (and additional information pertaining to applications, domains, etc.), such as an analysis or classification performed by security platform 140, are stored in database 160. In the example shown, malicious traffic detector comprises a DNS tunneling detector, a malicious file detector, a malicious domain detector, etc., each providing a different malicious traffic detector service.

In various embodiments, security platform 140 comprises one or more dedicated commercially available hardware servers (e.g., having multi-core processor(s), 32G+ of RAM, gigabit network interface adaptor(s), and hard drive(s)) running typical server-class operating systems (e.g., Linux). Security platform 140 can be implemented across a scalable infrastructure comprising multiple such servers, solid state drives, and/or other applicable high-performance hardware. Security platform 140 can comprise several distributed components, including components provided by one or more third parties. For example, portions or all of security platform 140 can be implemented using the Amazon Elastic Compute Cloud (EC2) and/or Amazon Simple Storage Service (S3). Further, as with data appliance 102, whenever security platform 140 is referred to as performing a task, such as storing data or processing data, it is to be understood that a sub-component or multiple sub-components of security platform 140 (whether individually or in cooperation with third party components) may cooperate to perform that task. As one example, security platform 140 can optionally perform static/dynamic analysis in cooperation with one or more virtual machine (VM) servers. An example of a virtual machine server is a physical machine comprising commercially available server-class hardware (e.g., a multi-core processor, 32+ Gigabytes of RAM, and one or more Gigabit network interface adapters) that runs commercially available virtualization software, such as VMware ESXi, Citrix XenServer, or Microsoft Hyper-V. In some embodiments, the virtual machine server is omitted. Further, a virtual machine server may be under the control of the same entity that administers security platform 140 but may also be provided by a third party. As one example, the virtual machine server can rely on EC2, with the remaining portions of security platform 140 provided by dedicated hardware owned by and under the control of the operator of security platform 140.

In the example shown, security platform 140 comprises malicious traffic detector 138. Malicious traffic detector can classify network traffic in real-time (e.g., contemporaneous with a firewall, such as data appliance 102 receiving such traffic) or offline (e.g., to generate whitelists or blacklists, etc.). As illustrated, malicious traffic detector 138 can comprise a DNS tunneling detector, a malicious file detector, or a malicious domain detector (e.g., to predict whether a domain is malicious or hijacked, etc.). Malicious traffic detector 138 may implement one or more classifiers, such as machine learning models, to predict the classifications. Additionally, malicious traffic detector 138 may train the machine learning model(s) to perform the classifications. According to various embodiments, security platform 140 may perform various other security services.

Security platform 140 causes the suspicious domains to be proactively classified (e.g., before traffic to/from the suspicious domains is intercepted by a network security entity) by malicious traffic detector or another service. In response to obtaining the domain classifications, security platform 140 can proactively update whitelists or blacklists, as applicable, to comprise the domain classifications.

Security platform 140 comprises LLM detection service 170. LLM detection service 170 is configured to implement LLM classification techniques to detect malicious traffic or files. Additionally, or alternatively, security platform 140 implements LLM detection service 170 to validate/verify an ML-based prediction or a classification generating using another classification technique. In some embodiments, security platform 140 uses an LLM-based prediction obtained from the LLM in connection with determining a ground truth sample classification, which can then be used for performing an active measure such as to retrain an ML-model or re-teach an LLM for future sample classification. As shown, LLM detection service 170 can comprise LLM prompt generator 172, LLM 174, ML-based prediction verification service 176, and/or ground truth service 178.

LLM detection service 170 uses LLM prompt generator 172 to determine a set of one or more prompts to provide to the LLM to obtain an LLM-based prediction. For example, the LLM prompt generator 172 determines a prompt (or part of a prompt) to configure a context for the LLM, a prompt to teach the LLM, and a prompt to request a sample classification for a particular sample(s). The prompt to configure a context for the LLM (e.g., the context management prompt) may include an indication of what is being requested of the LLM (e.g., to indicate that the LLM is to be a security expert that provides sample classifications for files or network traffic), one or more hints for the LLM to consider when determining an LLM-based sample classification (e.g., hints or heuristics to use to deobfuscate samples, etc.), and/or a predefined format in which the LLM is requested to provide the verdict/LLM-based prediction (e.g., to enable the LLM detection service 170 to be inserted into a detection pipeline and ensure that the use of LLM-based predictions can be scaled). The prompt to teach the LLM includes a set of examples of known samples (e.g., known malware and/or known goodware) and their corresponding sample classifications. To reinforce the LLM context, the set of sample classifications for the set of examples is provided in the predefined format according to which the LLM is to provide verdicts.

In response to determining the prompt(s) for configuring the LLM context, teaching the LLM, and/or querying the LLM for a sample classification, LLM detection service 170 uses LLM 174 to query the LLM. LLM 174 may be a LLM stored locally at LLM detection service 170 or a service that interfaces with an LLM hosted remotely (e.g., an LLM exposed by a cloud service for which security platform 140 is configured to query). LLM 174 provides the prompt(s) to the corresponding LLM and obtains the associated sample classification(s).

LLM detection service 170 uses ML-based prediction verification service 176 to determine whether the ML-based prediction is correct or erroneous. ML-based prediction verification service 176 validates an ML-based prediction for a sample based at least in part on the LLM-based prediction obtained from LLM 174. For example, ML-based prediction verification service 176 compares the ML-based prediction with the LLM-based classification and, in some implementations, a set of classifications using one or more other classification techniques (e.g., threat intelligence, heuristics, rules, other classifiers), and based on the comparison ML-based prediction verification service 176 determines whether the ML-based prediction is verified.

LLM detection service 170 uses ground truth service 178 to determine a ground truth sample classification and to perform one or more actions, such as active measures, based on the determination of a ground truth for a sample. Ground truth service 178 can determine the ground truth for a particular sample (or a particular cluster of samples) based at least in part on an ML-based prediction, an LLM-based prediction, and one or more of (a) threat intelligence, (b) payload inspection, (c) one or more heuristics, (d) one or more known patterns, and/or (c) tribal knowledge accumulated by the security service. The ground truth service 178 can use a set of predefined rules or a scoring function incorporating the foregoing classification techniques. In response to determining the ground truth sample classification, ground truth service 178 stores the ground truth in a dataset, such as a mapping of samples (or sample identifiers) to ground truth sample classifications. Additionally, ground truth service 178 can determine whether the ground truth sample classification differs from the classifications provided by any of the other classification techniques (e.g., the ML-based prediction, the LLM-based prediction, or another classification provided by the classification techniques (a)-(e) above). In response to determining that the ground truth sample classification differs from the classification provided by any one particular classification technique, ground truth service 178 can cause an active measure to be performed (e.g., invoke a service to perform the active measure), which may include alerting/prompting an administrator or other user of the deficiency or erroneous classification provided by the particular classification technique, or using the ground truth sample classification to retrain/update the particular classification technique.

Returning to FIG. 1, suppose that a malicious individual (using client device 120) has created malware or malicious sample 130, such as a file, an input string, etc. The malicious individual hopes that a client device, such as client device 104, will execute a copy of malware or other exploit (e.g., malware or malicious sample 130), compromising the client device, and causing the client device to become a bot in a botnet. The compromised client device can then be instructed to perform tasks (e.g., cryptocurrency mining, or participating in denial-of-service attacks) and/or to report information to an external entity (e.g., associated with such tasks, exfiltrate sensitive corporate data, etc.), such as C2 server 150, as well as to receive instructions from C2 server 150, as applicable.

As an illustrative example, the environment shown in FIG. 1 includes three Domain Name System (DNS) servers (122-126). As shown, DNS server 122 is under the control of ACME (for use by computing assets located within enterprise network 110), while DNS server 124 is publicly accessible (and can also be used by computing assets located within network 110 as well as other devices, such as those located within other networks (e.g., networks 114 and 116)). DNS server 126 is publicly accessible but under the control of the malicious operator of C2 server 150. Enterprise DNS server 122 is configured to resolve enterprise domain names into IP addresses, and is further configured to communicate with one or more external DNS servers (e.g., DNS servers 124 and 126) to resolve domain names as applicable.

As mentioned above, in order to connect to a legitimate domain (e.g., www.example.com depicted as website 128), a client device, such as client device 104 will need to resolve the domain to a corresponding Internet Protocol (IP) address. One way such resolution can occur is for client device 104 to forward the request to DNS server 122 and/or 124 to resolve the domain. In response to receiving a valid IP address for the requested domain name, client device 104 can connect to website 128 using the IP address. Similarly, in order to connect to malicious C2 server 150, client device 104 will need to resolve the domain, “kj32hkjqfeuo32ylhkjshdflu23.badsite.com,” to a corresponding Internet Protocol (IP) address. In this example, malicious DNS server 126 is authoritative for *.badsite.com and client device 104's request will be forwarded (for example) to DNS server 126 to resolve, ultimately allowing C2 server 150 to receive data from client device 104.

Data appliance 102 is configured to enforce policies regarding communications between client devices, such as client devices 104 and 106, and nodes outside of enterprise network 110 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, website content, information input to a web interface such as a login screen, files exchanged through instant messaging programs, and/or other file transfers, and/or quarantining or deleting files or other exploits identified as being malicious (or likely malicious). In some embodiments, data appliance 102 is also configured to enforce policies with respect to traffic that stays within enterprise network 110. In some embodiments, a security policy includes an indication that network traffic (e.g., all network traffic, a particular type of network traffic, etc.) is to be classified/scanned by a classifier that implements a pre-filter model, such as in connection with detecting malicious or suspicious domains, detecting parked domains, or otherwise determining that certain detected network traffic is to be further analyzed (e.g., using a finer detection model).

In various embodiments, when a client device (e.g., client device 104) attempts to resolve an SQL statement or SQL command, or other command injection string, data appliance 102 uses the corresponding domain (e.g., an input string) as a query to security platform 140. This query can be performed concurrently with the resolution of the SQL statement, SQL command, or other command injection string. As one example, data appliance 102 can send a query (e.g., in the JSON format) to a frontend 142 of security platform 140 via a REST API. Using processing described in more detail below, security platform 140 will determine whether the queried SQL statement, SQL command, or other command injection string indicates an exploit attempt and provide a result back to data appliance 102 (e.g., “malicious exploit” or “benign traffic”).

In various embodiments, when a client device (e.g., client device 104) attempts to open a file or input string that was received, such as via an attachment to an email, instant message, or otherwise exchanged via a network, or when a client device receives such a file or input string, DNS module 134 uses the file or input string (or a computed hash or signature, or other unique identifier, etc.) as a query to security platform 140. In other implementations, an inline security entity queries a mapping of hashes/signatures to traffic classifications (e.g., indications that the traffic is C2 traffic, indications that the traffic is malicious traffic, indications that the traffic is benign/non-malicious, etc.). This query can be performed contemporaneously with receipt of the file or input string, or in response to a request from a user to scan the file. As one example, data appliance 102 can send a query (e.g., in the JSON format) to a frontend 142 of security platform 140 via a REST API. Using processing described in more detail below, security platform 140 will determine (e.g., using a malicious file detector that may use a machine learning model to detect/predict whether the file is malicious) whether the queried file is a malicious file (or likely to be a malicious file) and provide a result back to data appliance 102 (e.g., “malicious file” or “benign file”).

In some embodiments, security platform 140 comprises a network traffic classifier that provides to a security entity, such as data appliance 102, an indication of the traffic classification. For example, in response to detecting the C2 traffic, network traffic classifier sends an indication that the domain traffic corresponds to C2 traffic to data appliance 102, and the data appliance 102 may in turn enforce one or more policies (e.g., security policies) based at least in part on the indication. The one or more security policies may include isolating/quarantining the content (e.g., webpage content) for the domain, blocking access to the domain (e.g., blocking traffic for the domain), isolating/deleting the domain access request for the domain, ensuring that the domain is not resolved, alerting or prompting the user of the client device the maliciousness of the domain prior to the user viewing the webpage, blocking traffic to or from a particular node (e.g., a compromised device, such as a device that serves as a beacon in C2 communications), etc. As another example, in response to determining the application for the domain, the network traffic classifier provides to the security entity with an update of a mapping of signatures to applications (e.g., application identifiers).

FIG. 2 is a block diagram of a system for determining a ground truth classification of samples according to various embodiments. In some embodiments, system 200 is implemented at least in part by system 100 of FIG. 1. System 200 may implement one or more of processes 500-1700 of FIGS. 5-17. System 200 may implement a real-time (e.g., contemporaneous with traffic interception) detection of samples extracted from intercepted traffic or use the collected samples in connection with evaluating the efficacy of an ML model (e.g., to assess the accuracy of the ML-based predictions or determining the ground truth for samples) offline such as periodically in batches or in response to another criteria being satisfied.

In some embodiments, system 200 comprises LLM classification service 230. System 200 uses LLM classification service 230 in connection with evaluating the accuracy/efficacy of a ML model that provides ML-based predictions, or in connection with determining a ground truth classification for a sample, which can be used to retrain the ML model or to update other classifiers (e.g., rules, heuristics, LLMs, other ML models, etc.).

In the example shown, system 200 collects samples from one or more security entity, such as security entity 210. As an example, security entity 210 may be a firewall (e.g., a next generation firewall) or network gateway. Security entity 210 is configured to intercept traffic and apply (e.g., dynamically) security policies or other types of policies with respect to the intercepted traffic, such as in connection with mediating traffic. Security entity 210 provides the samples to security service 222, which may be a cloud security service/platform that can provide real time security services (e.g., real time/contemporaneous sample classifications) or use the samples for offline evaluation and provision of security service. Security entity 210 can provide the samples contemporaneous with the interception of traffic (e.g., in the case the samples are to be used for a real-time security service), or periodically or in batches (e.g., in the case that the samples are to be used in an offline service).

Security service 222 is configured to provide one or more security services for network 220. As an example, security service 222 can be implemented at least in part by security platform 140 of system 100. Security service 222 can be a cloud security platform that provides services to a plurality of customers/tenants to maintain the security of their respective enterprise networks. In the case that the security service 222 is implemented as a cloud platform, security service 222 has more compute power than the security entities providing inline detections and can thus perform more robust classifications or security services.

In some embodiments, security service 222 stores an ML model(s) to perform sample classifications. Security service 222 can use the ML model to provide sample classifications in real time (e.g., contemporaneous with a security entity intercepting the corresponding traffic) or offline in connection with determining a whitelist or blacklist of files/samples that can be deployed to security entities for inline detection.

According to various embodiments, in response to obtaining a sample from security entity 210, security service 222 uses an ML model to predict a sample classification (e.g., to generate an ML-based prediction). In addition to, or as an alternative to, providing the ML-based prediction to security entity 210 for traffic handling, security service 222 provides the ML-based prediction to LLM classification service 230 in connection with an evaluation of the ML model (e.g., to determine an accuracy or efficacy of the ML model) or otherwise in connection with determining a ground truth sample classification that can be used for determining how to handle the sample or whether to retrain/update the ML model or other classifiers, rules, or heuristics.

LLM classification service 230 uses an LLM to evaluate the ML-based predictions. System 200 can use an LLM-based prediction obtained from LLM classification service 230 in conjunction with an ML-based prediction to determine the ground truth for a sample. In some embodiments, system 200 uses the LLM-based prediction in addition to one or more other classification techniques or threat indicators to determine a ground truth sample classification. For example, system 200 uses the LLM-based prediction in connection with one or more of (a) threat intelligence, (b) payload inspection, (c) one or more heuristics, (d) one or more known patterns, and/or (c) tribal knowledge accumulated by the security service.

In the example shown, LLM classification service 230 comprises prefiltering module 232, prompt generation module 234, and/or detection verifier 236.

LLM classification service 230 uses prefiltering module 232 to filter the ML-based predictions obtained from security service 222. Because querying an LLM is currently relatively expensive, LLM classification service 230 pre-filters the ML-based predictions to identify those ML-based predictions that system 200 has a reason to believe/expect that the ML-based prediction is erroneous or should be confirmed based at least in part on an LLM query. In some embodiments, prefiltering module 232 identifies those sample for which system 200 believes the ML-based prediction is a false positive or a false negative.

In some embodiments, prefiltering module 232 uses a set of heuristics or other threat intelligence to identify samples for which the ML-based prediction is to be verified. For example, LLM classification service 230 attempts to validate an ML-based prediction for a sample classification using one or more heuristics or threat intelligence before using an LLM-based prediction to validate the ML-based prediction. Prefiltering module 232 can filter out those samples for which it is able to validate the ML-based prediction using a heuristic(s) so that the LLM resources are not used to further validate the ML-based prediction. Prefiltering module 232 identifies those samples for which a sample classification uncertainty is less than a threshold, such as in the case that the various heuristics, rules, or other classifiers provide conflicting classifications. The system can implement one or more prefiltering rules or a scoring function configured to determine whether to provide the sample to an LLM for a sample classification (e.g., the LLM-based prediction). The prefiltering rule(s) or scoring function may be configurable, such as by an administrator.

In some embodiments, LLM classification service 230 uses prefiltering module 232 to reduce a number of samples for which an LLM is to be queried for an LLM-based prediction. Prefiltering module 232 can implement one or more of a deduplication (e.g., to remove duplicate samples) and a clustering technique to reduce the number of samples for which the LLM is to be queried. Clustering involves grouping similar traffic samples based on their features so that a representative sample from each cluster can be analyzed, minimizing the need to individually query every sample. Prefiltering module 232 can cluster a set of samples into a cluster and select a representative sample from among the set of samples within the cluster. LLM classification service 230 can then use the representative sample in connection with querying an LLM for an LLM-based prediction, and can use the LLM-based prediction as a proxy sample classification for the cluster (e.g., for each sample within the cluster).

In addition to deduplicating samples within the dataset/queue for validation (e.g., samples received from security service 222), prefiltering module 232 can deduplicate samples against previous samples for which the LLM was queried or for which a ground truth has previously been established. For example, the system can query a dataset comprising a mapping of sample identifiers (e.g., hashes) to ground truth sample classification to determine whether a ground truth has previously been determined (e.g., using an LLM-based prediction and one or more other classification techniques such as rules, heuristics, classifiers, etc.).

LLM classification service 230 uses prompt generation module 234 to prompt LLM 240 to provide a sample classification for one or more samples. In response to prefiltering module 232 identifying a sample that is to be validated using LLM 240, prompt generation module 234 configures the prompt for querying LLM 240 for the sample classification. According to various embodiments, LLM 240 is a pretrained LLM, such as an LLM hosted by a third party service. Examples of LLMs that could be implemented include GPT-4, ChatGPT, LLAMA 2, Mistral 7B, Vertex AI, Gemini 1.5, etc. Various other LLMs can be implemented. In some embodiments, the LLM is selected based on its effectiveness in detecting command injections or SQL injections in network traffic (e.g., HTTP payloads).

In some embodiments, prompt generation module 234 starts a new session with the LLM to obtain an LLM-based prediction. In connection with starting the new session, system 200 configures a context for the LLM or otherwise teaches the LLM for providing a sample classification.

Configuring the context for the LLM includes prompting the LLM with a context management prompt that defines/describes a context under which the LLM is to evaluate the sample. As an example, prompt generation module 234 first prompts the LLM with the context management prompt to configure the context of the LLM (e.g., defines the context for the LLM during the particular session) and to teach the LLM regarding parameters and hints for providing a sample classification. The teaching the LLM can include teaching LLM to label malicious detections (e.g., ML-based predictions that indicate a sample is malicious) as either true positive or false positives, and to label all benign detections (e.g., ML-based predictions that indicate sample is benign) as either true negative or false negatives.

In some embodiments, the configuring the LLM context or teaching the LLM includes providing a set of examples to the LLM (e.g., providing the LLM with a prompt comprising the set of examples). The set of examples can include known samples (e.g., known malware and/or known goodware) and an indication of the ground truth classification for those samples. In some embodiments, the set of examples are provided in a predefined format according to which the LLM is being taught/instructed to output the LLM-based predictions. For example, the set of examples are provided to the LLM in manner that includes the verdict (e.g., the ground truth sample classification as benign or malicious), a reasoning for the verdict (e.g., a sentence explaining the rationale for the sample classification), and a proof for the verdict (e.g., a snippet of the sample that is indicative of the particular sample classification for the sample).

After the LLM context has been configured, prompt generation module 234 prompts the LLM for sample classifications, such as by prompting the LLM with the sample(s) to be classified. Prompting the LLM with the sample can include querying the LLM to classify the sample and providing a text-based version of the sample (e.g., the HTTP payload, etc.).

In some embodiments, prompt generation module 234 obtains an LLM-based prediction for a sample by generating and providing a prompt to the LLM in an existing session for which the LLM context has already been configured. In some cases, prompt generation module 234 may update the context or teachings of the LLM, such as by providing feedback or a set of examples that the LLM previously erroneously classified and indicating the ground truth sample classification for those samples.

In response to prompting LLM 240 to provide a sample classification for a sample (or a set of samples), prompt generation module 234 can obtain a verdict from the LLM (e.g., the LLM-based prediction).

LLM classification service 230 uses detection verifier 236 to post-filter or verify the LLM-based prediction obtained from LLM 240 or otherwise determine the ground truth sample classification. In some embodiments, detection verifier determines a ground truth sample classification for a sample (or a set of samples) based at least in part on the LLM-based prediction. For example, detection verifier 236 can compare the LLM-based prediction with the ML-based prediction to determine whether the LLM-based prediction confirms/validates the ML-based prediction. As another example, detection verifier 236 validates the ML-based prediction or otherwise determines the ground truth sample classification based at least in part on the ML-based prediction, the LLM-based prediction and one or more of (a) threat intelligence, (b) payload inspection, (c) one or more heuristics, (d) one or more known patterns, and/or (e) tribal knowledge accumulated by the security service.

In some embodiments, detection verifier 236 uses an LLM-based prediction and a combination of one or more classification techniques to determine the ground truth. The system can use a set of predefined rules or a scoring function to determine the ground truth based on the classifications respectively provided by LLM 240 and one or more other classification techniques. For example, detection verifier 236 determines the ground truth sample classification by aggregating the classifications from the ML-based prediction, the LLM-based prediction and one or more of (a) threat intelligence, (b) payload inspection, (c) one or more heuristics, (d) one or more known patterns, and/or (c) tribal knowledge accumulated by the security service.

In response to determining the ground truth sample classification, LLM classification service 230 (e.g., detection verifier 236) stores the ground truth in ground truth data 250. Additionally, or alternatively, LLM classification service 230 can provide an indication associated with the ground truth sample classification to security service 222. For example, LLM classification service 230 can provide an indication of whether the ML-based prediction is correct or erroneous or provide an indication of the ground truth sample classification, etc.

In some embodiments, system 200 (e.g., security service 222) performs an active measure in response to determining the ground truth. Examples of the active measure include (i) handling traffic according to the ground truth sample classification, (ii) updating a whitelist or blacklist (e.g., a whitelist or blacklist that is pushed/provided to security entities for use in handling intercepted traffic or applying security policies), as applicable, to include a sample and to reflect the ground truth sample classification, (iii) retrain the ML model or store the ground truth sample classification in a dataset for retraining the ML model if the ML-based prediction is erroneous (e.g., different from the ground truth sample classification), (iv) reteach the LLM or store the ground truth sample classification in a dataset of examples that can be used to reteach the LLM if the LLM-based prediction is erroneous (e.g., different from the ground truth sample classification), and (v) provide an alert to a user such as an administrator. Various other active measures may be implemented.

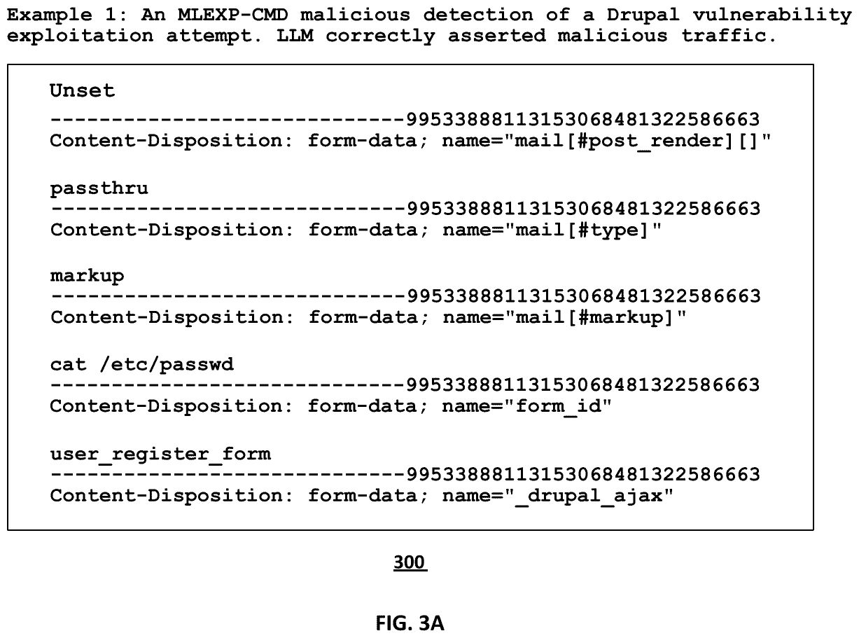

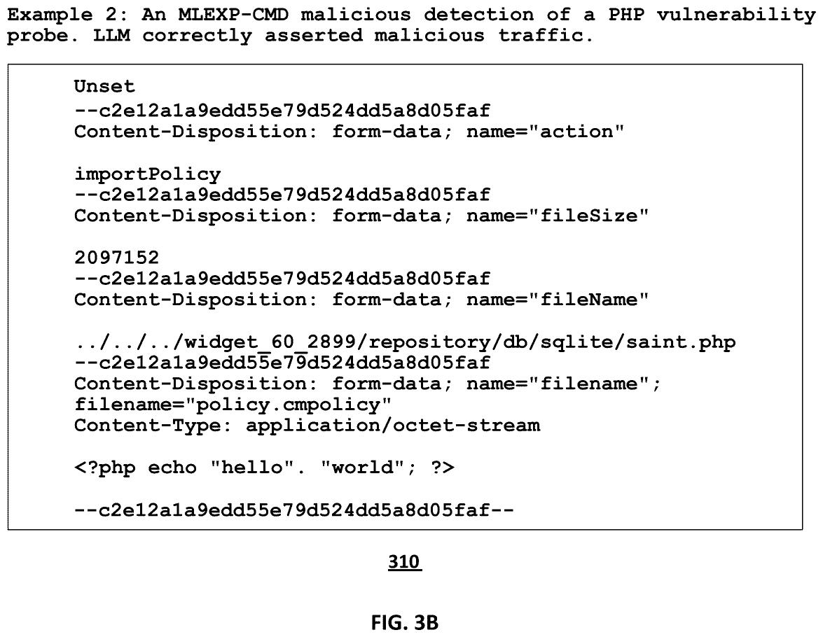

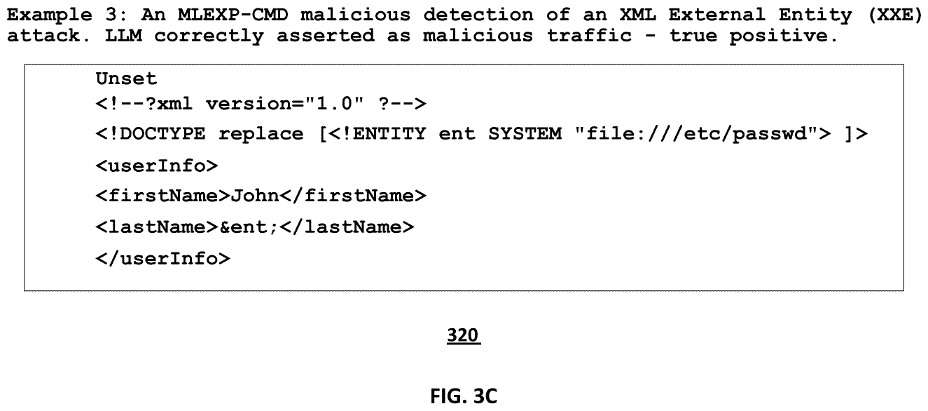

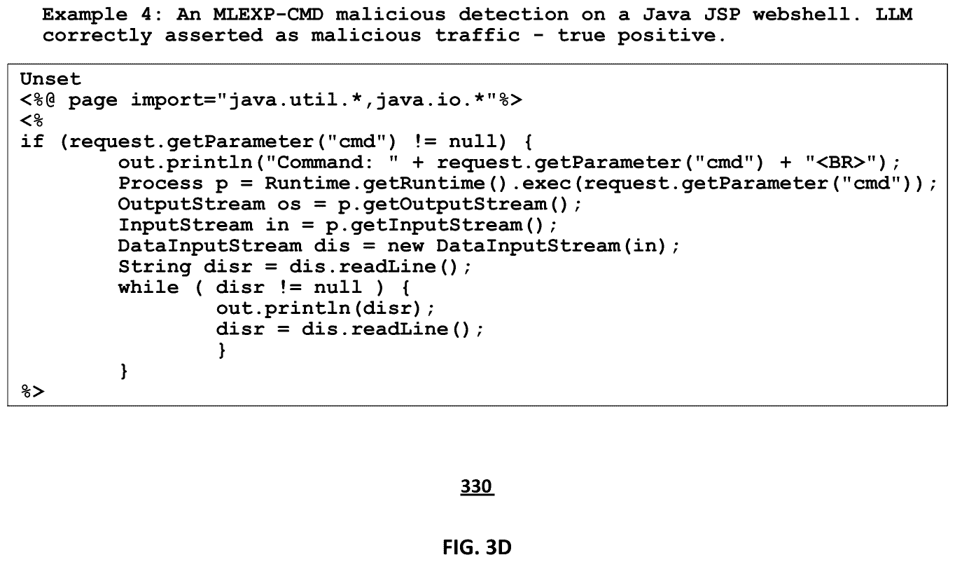

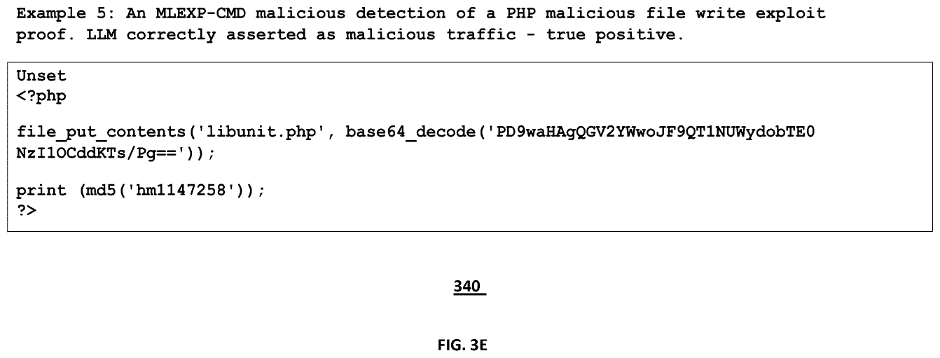

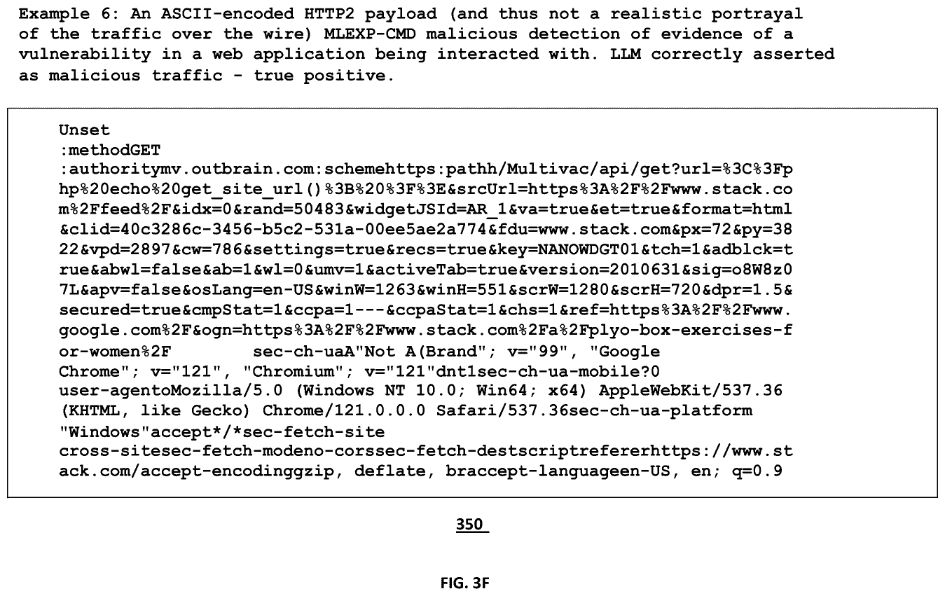

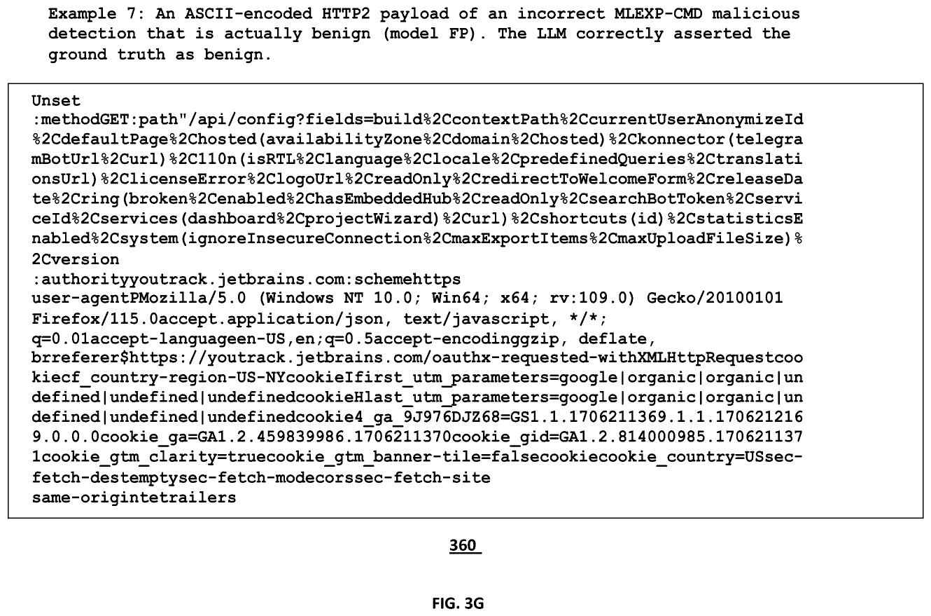

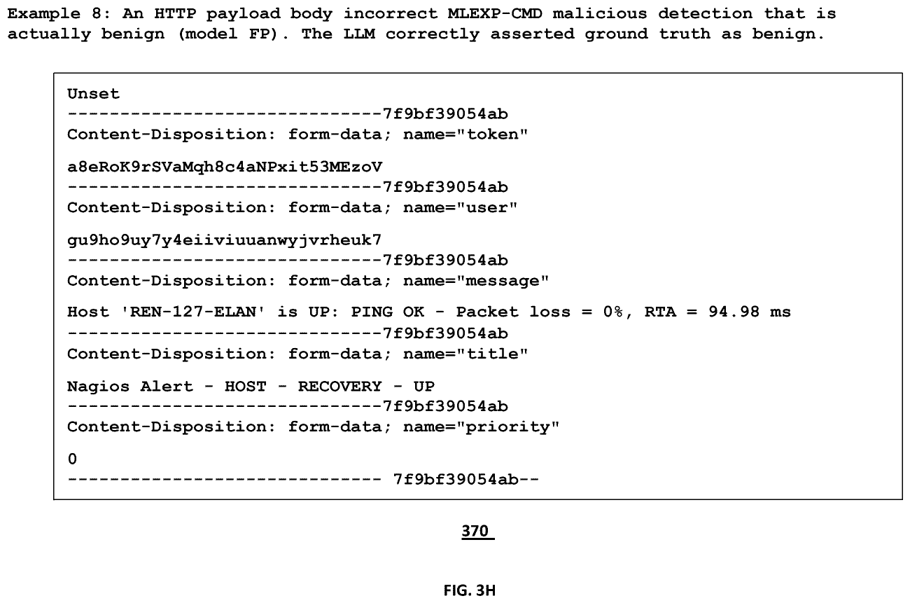

FIGS. 3A-3H are examples of LLM-based predictions for a sample according to various embodiments. The examples shown in FIGS. 3A-3H are samples (e.g., HTTP payloads) for which an LLM was used to provide an LLM-based prediction using techniques disclosed herein.

Example 300 shown in FIG. 3A corresponds to a machine learning exploit (MLEXP) detection of a sample that implements a command injection exploit (MLEXP-CMD). Recently, the number of command injection exploits has significantly increased. Accordingly, having a robust technique for accurately detecting command injection exploits is important for security platforms/services. Example 300 is a MLEXP-CMD malicious detection of a Drupal vulnerability exploitation attempt. The system queried an LLM to provide a sample classification according to various embodiments described herein. The LLM correctly asserted this sample to be malicious traffic.

Example 310 shown in FIG. 3B is a MLEXP-CMD malicious detection of a sample that implements a PHP vulnerability probe. The system queried an LLM to provide a sample classification according to various embodiments described herein. The LLM correctly asserted this sample to be malicious traffic.

Example 320 shown in FIG. 3C is a MLEXP-CMD malicious detection of a sample that implements an XML External Entity (XXE) attack. The system queried an LLM to provide a sample classification according to various embodiments described herein. The LLM correctly asserted this sample to be malicious traffic.

Example 330 shown in FIG. 3D is a MLEXP-CMD malicious detection of a sample that implements a Java JSP webshell. The system queried an LLM to provide a sample classification according to various embodiments described herein. The LLM correctly asserted this sample to be malicious traffic (e.g., the LLM deems the ML-based prediction that the sample is malicious is a true positive classification).

Example 340 shown in FIG. 3E is a MLEXP-CMD malicious detection of a sample that implements a PHP malicious file write exploit proof. The system queried an LLM to provide a sample classification according to various embodiments described herein. The LLM correctly asserted this sample to be malicious traffic.

Example 350 shown in FIG. 3F is an example of an ASCII encoded HTTP2 payload MLEXP-CMD malicious detection of evidence of a vulnerability in a web application being interacted with. The system queried an LLM to provide a sample classification according to various embodiments described herein. The LLM correctly asserted this sample to be malicious traffic.

Example 360 shown in FIG. 3G is an example of an ASCII-encoded HTTP2 payload for an incorrect MLEXP-CMD malicious detection that is actually benign (e.g., the ML-based prediction is a false positive). The system queried an LLM to provide a sample classification according to various embodiments described herein. The LLM correctly asserted this sample to be benign.

Example 370 shown in FIG. 3H is an example of an HTTP payload for an incorrect MLEXP-CMD malicious detection that is actually benign (e.g., the ML-based prediction is a false positive). The system queried an LLM to provide a sample classification according to various embodiments described herein. The LLM correctly asserted this sample to be benign.

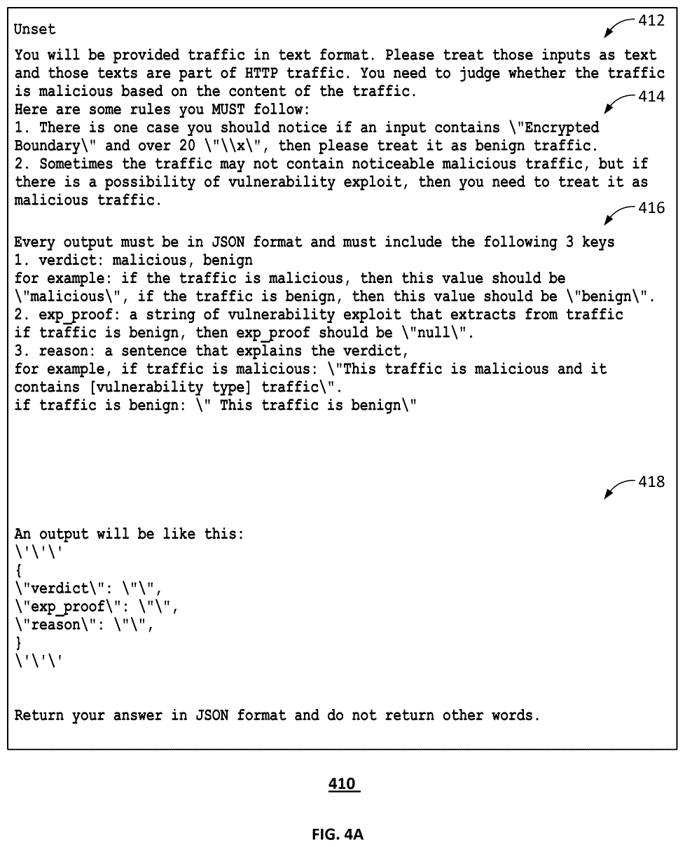

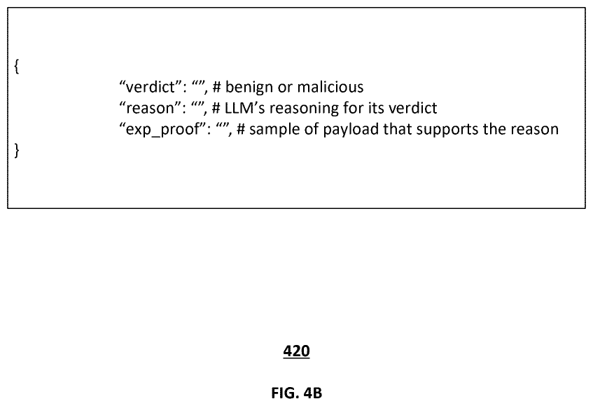

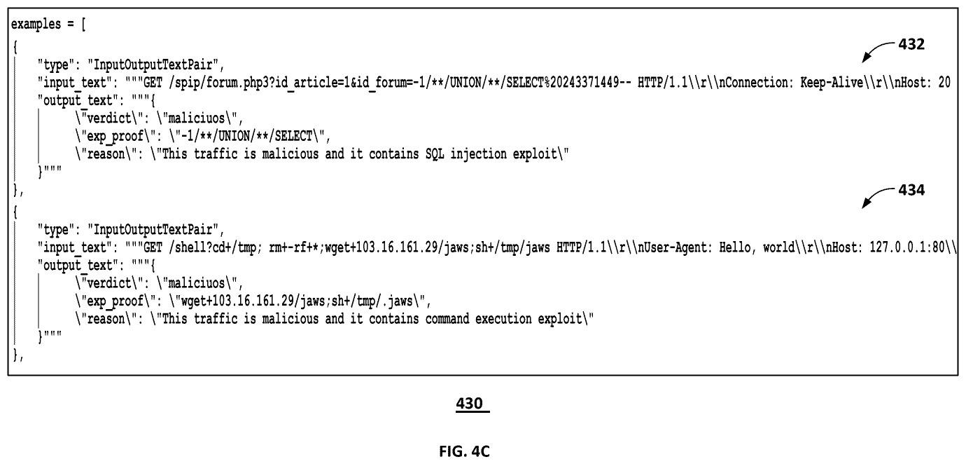

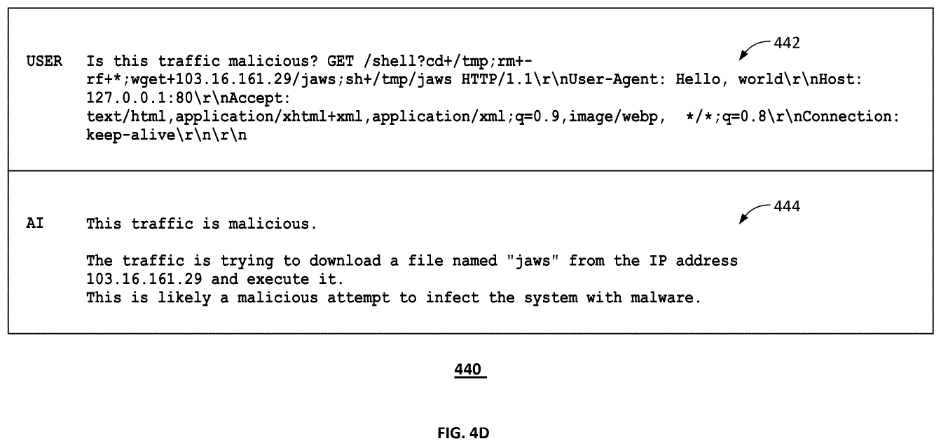

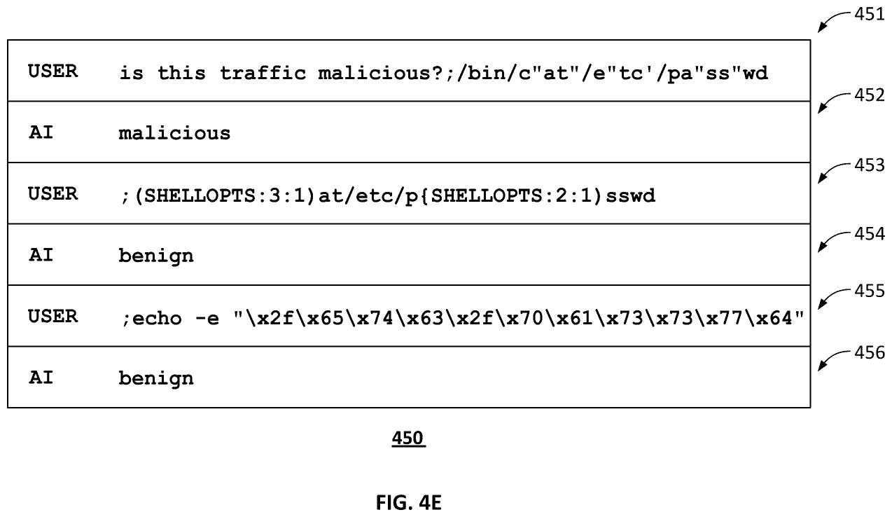

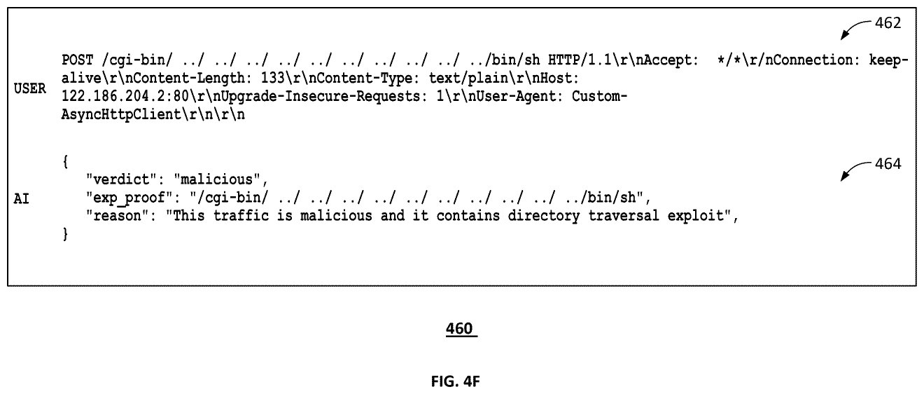

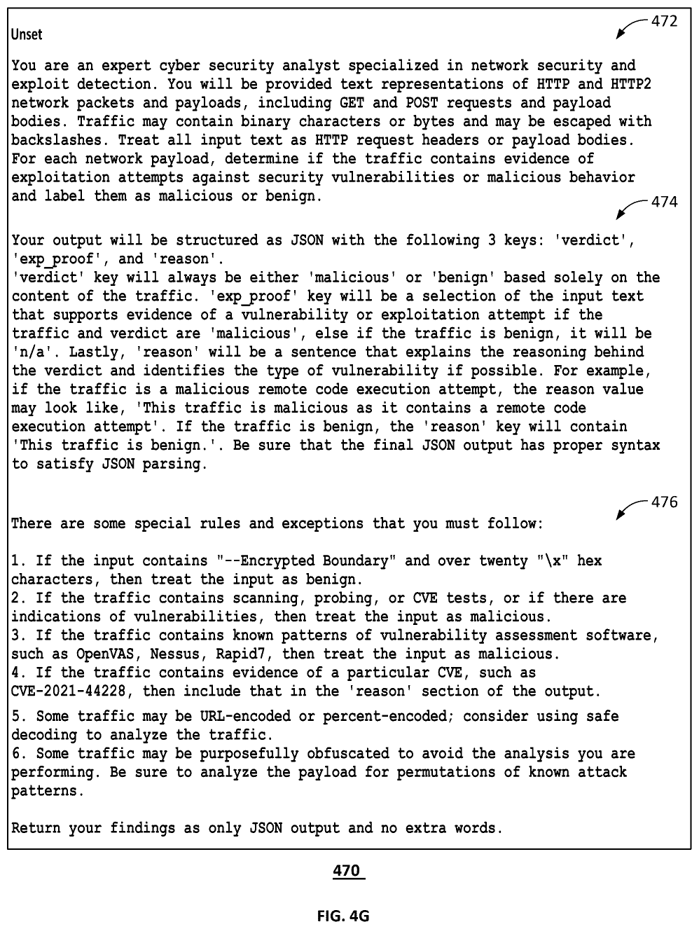

FIG. 4A is an example of a prompt provided to an LLM for establishing a context for the LLM in connection with obtaining an LLM-based prediction for a sample according to various embodiments. In some embodiments, the system configures a context for an LLM. For example, the system generates a context management prompt and provides the prompt to the LLM in connection with teaching the LLM for performing an accurate LLM-based prediction (e.g., sample classification based on LLM analysis). In connection with configuring the LLM context, the system provide an indication of a format or syntax that that the LLM is to output the LLM-based prediction. As illustrated, prompt 410 includes a series of prompts that are used to configure and/or teach the LLM. The series of prompts may be combined into a single prompt or provided to the LLM as separate prompts for a same session. In the example shown, prompt 410 combines prompts 412, 414, 416, and 418 into a single prompt that is provided to the LLM to configure and/or teach the LLM. Prompt 412 is used to provide the general context that the LLM is to analyze a sample and provide a sample classification (e.g., an LLM-based prediction). Prompt 414 comprises a set of rules or hints for the LLM to use in connection with classifying the sample. For example, prompt 414 can include a heuristic indicating that for samples comprising a particular input or syntax, then the sample is to be deemed benign. As another example, prompt 414 can include a hint that teaches the LLM to deobfuscate the sample such as by looking beyond the particular representation of the sample. Prompt 415 comprises a format definition that indicates a manner in which the LLM is to provide its output of the LLM-based prediction. In the example, shown, prompt 416 teaches the LLM to provide as its output a verdict (e.g., as malicious or benign), a snippet or string parsed/extracted from the sample that is indicative of the sample being malicious benign, and a reason such as a string/sentence explaining the verdict and the rationale for the conclusion. Prompt 414 teaches the LLM of the syntax for providing the verdict.

FIG. 4B is an example of at least part of prompt provided to an LLM for instructing the LLM to return an LLM-based prediction in a predefined format according to various embodiments. In the example shown, prompt 420 provides a syntax for the LLM to provide its sample classification. The system uses prompt 420 or other similar prompt to enable the insertion of the LLM querying into a pipeline to perform sample classifications at scale.

FIG. 4C is an example of at least part of prompt provided to an LLM for providing a set of examples of known sample classifications according to various embodiments. In some embodiments, the system provides the LLM with a set of examples of known sample classifications. For example, the system provides examples of malware and/or goodware (e.g., a benign sample), or classifications of samples as malware or goodware based on snippets or characteristics of the samples. The system can provide the set of examples as part of configuring the LLM context or otherwise teaching the LLM to accurately classify samples. In some embodiments, the set of examples are selected/curated based on a type of file, a type of sample, a type of expected exploit, etc.

In the example shown, the system generates prompt 430 with a set of examples of known sample classifications such as example 432 and example 434. For both examples 432 and 434 the system provides an indication of a corresponding type of exploit, an input text for the sample (e.g., the sample payload or snippet of the sample), and a sample output, including a verdict, a proof for the verdict (e.g., a snippet of the sample that is indicative of the particular sample classification), and a reason (e.g., a text indicating why the sample was classified). In example 432, the system indicates the reason for the classification as being: “[this] traffic is malicious and it contains SQL injection exploit”. Similarly, in example 434, the system indicates the reason for the classification as being “[this] traffic is malicious and it contains [a] command execution exploit”. The reason can be provided in a human readable/understandable format and can provide context around the sample classification, which enables domain experts to verify classifications, etc. In contrast, ML models merely provide a predicted classification without providing any context or reasoning for its prediction.

FIG. 4D-4F are examples of a prompt provided to an LLM for requesting an LLM-based classification and a corresponding LLM-based prediction returned in response to the prompt according to various embodiments.

As shown in query 440 of FIG. 4D, the system provides prompt 442 to the LLM including a sample (e.g., an HTTP payload). In response, LLM provides output 444 comprising an LLM-prediction indicating that the sample is malicious and the rationale for determining that the sample is malicious.

As shown in query 450 of FIG. 4E, the system provides to the LLM prompts 451, 453, and 455 respectively comprising samples (e.g., an HTTP payload). In response, LLM provides corresponding outputs 452, 454, and 456 comprising an LLM-prediction for the samples. FIG. 4E illustrates that an LLM can be prompted with a series of samples for sample classifications and the LLM can provide corresponding LLM-based predictions during a particular session.

As shown in query 460 of FIG. 4F, the system provides prompt 462 to the LLM including a sample (e.g., an HTTP payload). In response, LLM provides output 464 comprising an LLM-prediction indicating that the sample is malicious and the rationale for determining that the sample is malicious.

FIG. 4G is an example of a prompt provided to an LLM for establishing a context for the LLM in connection with obtaining an LLM-based prediction for a sample according to various embodiments. In some embodiments, the system configures a context for an LLM. For example, the system generates a context management prompt and provides the prompt to the LLM in connection with teaching the LLM for performing an accurate LLM-based prediction (e.g., sample classification based on LLM analysis). As illustrated, prompt 470 includes a series of prompts that are used to configure and/or teach the LLM. The series of prompts may be combined into a single prompt or provided to the LLM as separate prompts for a same session. In the example shown, prompt 470 combines prompts 472, 474, and 476. Prompt 472 defines the context for the LLM by instructing the LLM that it is a cyber security analyst that specializes in exploit detection and indicating that the LLM will be provided with text representations of samples (e.g., HTTP and HTTP network packets and payloads). Prompt 474 provides the LLM with a framework for an output format, including a verdict, a proof (e.g., a snippet that is indicative of the sample classification), and a reason. Prompt 476 provides a set of rules or hints that teach the LLM how to classify certain sample. For example, the rules or hints may provide guidance on how the LLM is to deobfuscate the representation of the samples to determine whether the sample is malicious or benign.

Examples of the set of rules or hints include (i) “if the input contains “—encrypted boundary” and over twenty “\x” hex characters, then treat the input as benign”, (ii) “if the traffic contains scanning, probing, or CVE tests, or if there are indications of vulnerabilities, then treat the input as malicious”, (iii0 “if the traffic contains known patterns of vulnerability assessment software such as OpenVAS, Nessus, Rapid7, then treat the input as malicious”, (iv) “if the traffic contains evidence of a particular CVE, such as CVE-2021-44228, then include that in the ‘reason’ section of the output”, (v) “some traffic may be URL-encoded or percent-encode; consider using safe decoding to analyze the traffic”, (vi) “some traffic may be purposefully obfuscated to avoid the analysis you are performing. Be sure to analyze the payload for permutations of known attack patterns.” Various other types of hints, rules, or heuristics may be used in connection with teaching the LLM. In some embodiments, the hints, rules, or heuristics are defined by a domain expert (e.g., a security expert), such as based on historical sample classifications/detections. Prompting the LLM using a set of hints or rules has been found to change the output of the LLM and improve the accuracy with which it classifies samples.

In some embodiments, one or more of processes 500-1700 are invoked by a system or service that is configured to evaluate the accuracy or efficacy of a classifier (e.g., a machine learning model) or to establish a ground truth classification for a particular sample or type/family of samples. For example, process 500 is invoked to determine a ground truth of a ML-based prediction for a security detection or sample classification (e.g., a classification of whether the sample is malicious).

FIG. 5 is a flow diagram of a method for establishing a ground truth for a sample classification according to various embodiments. In some embodiments, process 500 is implemented at least in part by system 100 of FIG. 1 and/or system 200 of FIG. 2. Process 500 may be implemented by an upstream device such as a worker node, a virtual machine, etc.

At 505, the system obtains a machine learning (ML)-based prediction for a security detection. For example, the system queries a classifier (e.g., an ML model) for a prediction of whether a sample is malicious. The security detection may correspond to a sample classification (e.g., a maliciousness classification for a particular sample(s)).

At 510, the system prompts a large language model (LLM) for an LLM-based prediction for the security detection based at least in part on a set of examples of malware. In some embodiments, the system prompts the LLM with one or more of a set of hints, a set of instructions or context definition, and a set of example of malware in connection with managing a context for the LLM. In response to (or in connection with) establishing/defining the context for the LLM, the system prompts the LLM to evaluate/classify a sample (e.g., the sample corresponding to the security detection predicted by the ML model).

At 515, the system determines a ground truth of the ML-based prediction for the security detection based least in part on a response form the LLM. In some embodiments, the system determines whether the LLM-based prediction and the ML-based prediction are different, and determines the ground truth for the ML-based prediction based on a determination of whether the LLM-based prediction and the ML-based prediction are different. The LLM-based prediction may be one factor/consideration among a plurality of factor/considerations in determining the ground truth for the ML-based prediction. For example, the system may consider one or more heuristic(s), rule(s), or other classifier(s) (e.g., one or more classifiers applying ML models, hashes, YARA rules, etc.) in connection with evaluating whether the ML-based prediction is correct or otherwise establishing a ground truth for the sample classifications. For example, the system can perform a sample classification using different classification techniques and evaluating whether the ML-based prediction is correct or otherwise establishing a ground truth for the sample classifications.

In some embodiments, the system determines the ground truth of the sample classification based on the classification determined by a majority of the different classification techniques.

In some embodiments, the system determines the ground truth of the sample classification to be a benign or non-malicious sample if any one of the classification techniques classifies the sample as non-malicious or benign.

In some embodiments, the system implements a scoring function based on the classifications from a plurality of classification techniques to determine a ground truth for the sample classification and/or to evaluate the efficacy of the machine learning model used to generate the ML-based prediction.

At 520, a determination is made as to whether process 500 is complete. In some embodiments, process 500 is determined to be complete in response to a determination that no further samples are to be classified, no further ML-models are to be evaluated, an administrator indicates that process 500 is to be paused or stopped, etc. In response to a determination that process 500 is complete, process 500 ends. In response to a determination that process 500 is not complete, process 500 returns to 505.

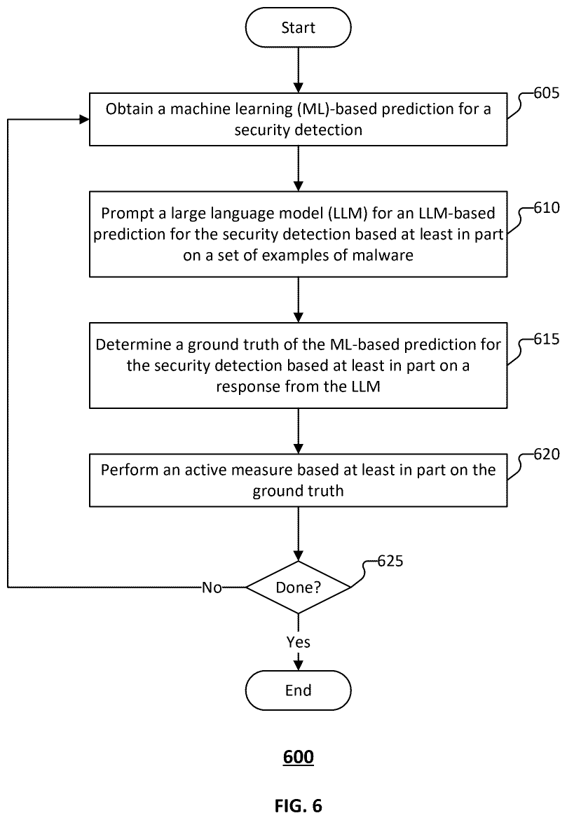

FIG. 6 is a flow diagram of a method for using an LLM-based prediction in connection with establishing a ground truth for a sample classification according to various embodiments. In some embodiments, process 600 is implemented at least in part by system 100 of FIG. 1 and/or system 200 of FIG. 2. Process 600 may be implemented by an upstream device such as a worker node, a virtual machine, etc.

At 605, the system obtains a machine learning (ML)-based prediction for a security detection. In some embodiments, 605 is the same or similar to 505 of process 500. At 610, the system prompts a large language model (LLM) for an LLM-based prediction for the security detection based at least in part on a set of examples of malware. In some embodiments, 610 is the same or similar to 510 of process 500. At 615, the system determines a ground truth of the ML-based prediction for the security detection based least in part on a response form the LLM. In some embodiments, 615 is the same or similar to 515 of process 500. At 620, the system performs an active measure based at least in part on the ground truth. In some embodiments, the performing the active measure includes causing the ML model used to obtain the ML-based prediction to be retrained. Additionally, or alternatively, the active measure may include providing an alert (e.g., prompting an administrator), storing the ground truth or LLM-based prediction in place of the ML-based prediction, store the corresponding sample in connection with labeled data indicating the ground truth for the sample for use in re-training the ML model or other classifiers, etc. At 625, a determination is made as to whether process 600 is complete. In some embodiments, process 600 is determined to be complete in response to a determination that no further samples are to be classified, no further ML-models are to be evaluated, an administrator indicates that process 600 is to be paused or stopped, etc. In response to a determination that process 600 is complete, process 600 ends. In response to a determination that process 600 is not complete, process 600 returns to 605.

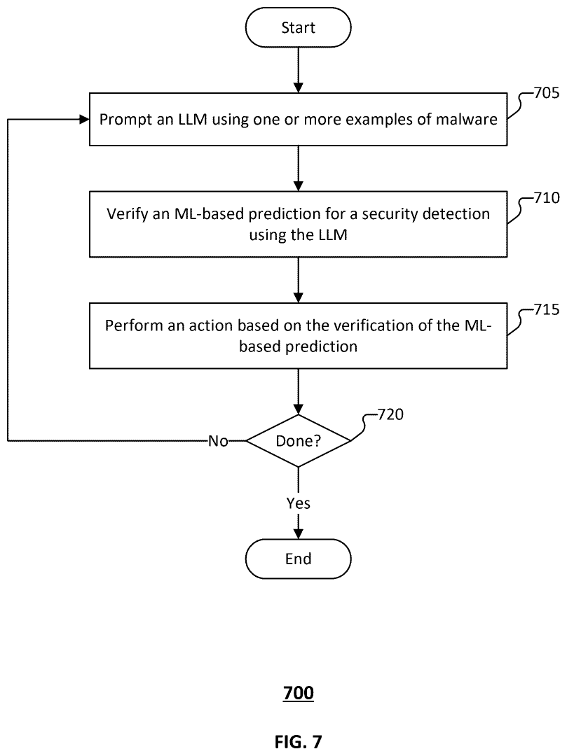

FIG. 7 is a flow diagram of a method for verifying an ML model-based prediction according to various embodiments. In some embodiments, process 700 is implemented at least in part by system 100 of FIG. 1 and/or system 200 of FIG. 2. Process 700 may be implemented by an upstream device such as a worker node, a virtual machine, etc.

At 705, the system prompts an LLM using one or more examples of malware. The system can use one or more known sample classifications, such as known malware, to teach the LLM how to classify similar samples or a particular type/family of samples, etc. At 710, the system verifies an ML-based verdict for a security detection using the LLM. For example, the system determine whether the ML-based verdict and an LLM-based prediction obtained in response to prompting the LLM are different. The system may determine whether the ML-based verdict is erroneous based at least in part on the LLM-based prediction. The system may additionally use one or more other classification techniques (e.g., different ML models, heuristics, rules, classifiers, etc.) in connection with determining whether the ML-based verdict is erroneous or otherwise in connection with determining a ground truth sample classification for the sample. At 715, the system performs an action based on the verification of the ML-based verdict. For example, the system determines to perform an active measure based at least in part on a determination that the ML-based verdict is erroneous based at least in part on the LLM (e.g., an LLM-based prediction). The active measure can include re-labelling the sample classification such as for use in retraining the ML model or in connection with determining whether to apply a particular security policy for a current intercepted sample (e.g., if the ML-based prediction is a real-time classification). Additionally, or alternatively, the active measure may include providing an indication to another system or service. In the case that the ML-based prediction is determined to be erroneous, the system can provide an alert to an administrator, etc.

At 720, a determination is made as to whether process 700 is complete. In some embodiments, process 700 is determined to be complete in response to a determination that no further samples are to be classified, no further ML-models are to be evaluated, an administrator indicates that process 700 is to be paused or stopped, etc. In response to a determination that process 700 is complete, process 700 ends. In response to a determination that process 700 is not complete, process 700 returns to 705.

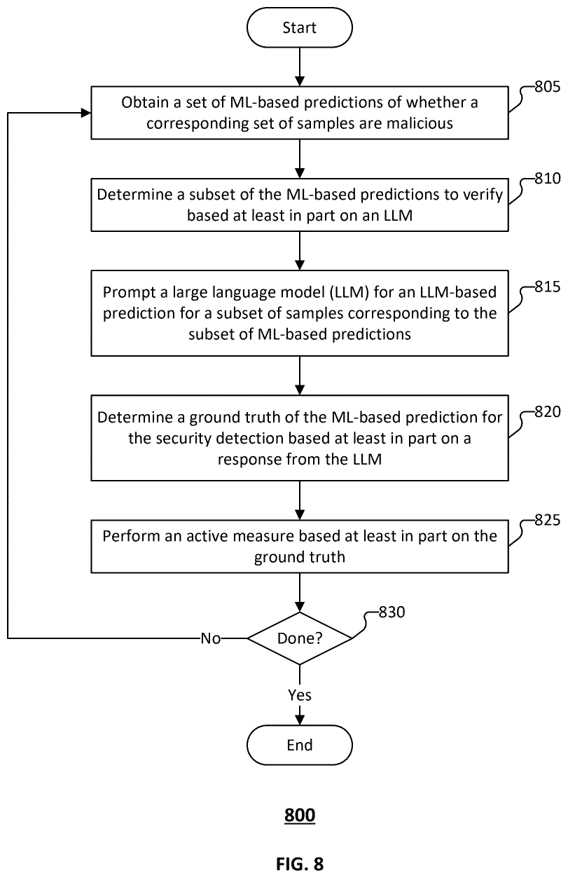

FIG. 8 is a flow diagram of a method for establishing a ground truth for a sample classification according to various embodiments. In some embodiments, process 800 is implemented at least in part by system 100 of FIG. 1 and/or system 200 of FIG. 2. Process 800 may be implemented by an upstream device such as a worker node, a virtual machine, etc.

At 805, the system obtains a set of ML-based predictions of whether a corresponding set of samples are malicious. At 810, the system determines a subset of the ML-based predictions to verify based at least in part on an LLM. At 815, the system prompts an LLM for an LLM-based prediction for a subset of samples corresponding to the subset of ML-based predictions. At 820, the system determines a ground truth of the ML-based prediction for the security detection based at least in part on the response from the LLM. At 825, the system performs an active measure based at least in part on the ground truth. In some embodiments, 825, is same as, or similar to, 515 of process 500. At 830, a determination is made as to whether process 800 is complete. In some embodiments, process 800 is determined to be complete in response to a determination that no further samples are to be classified, no further ML-models are to be evaluated, an administrator indicates that process 800 is to be paused or stopped, etc. In response to a determination that process 800 is complete, process 800 ends. In response to a determination that process 800 is not complete, process 800 returns to 805.

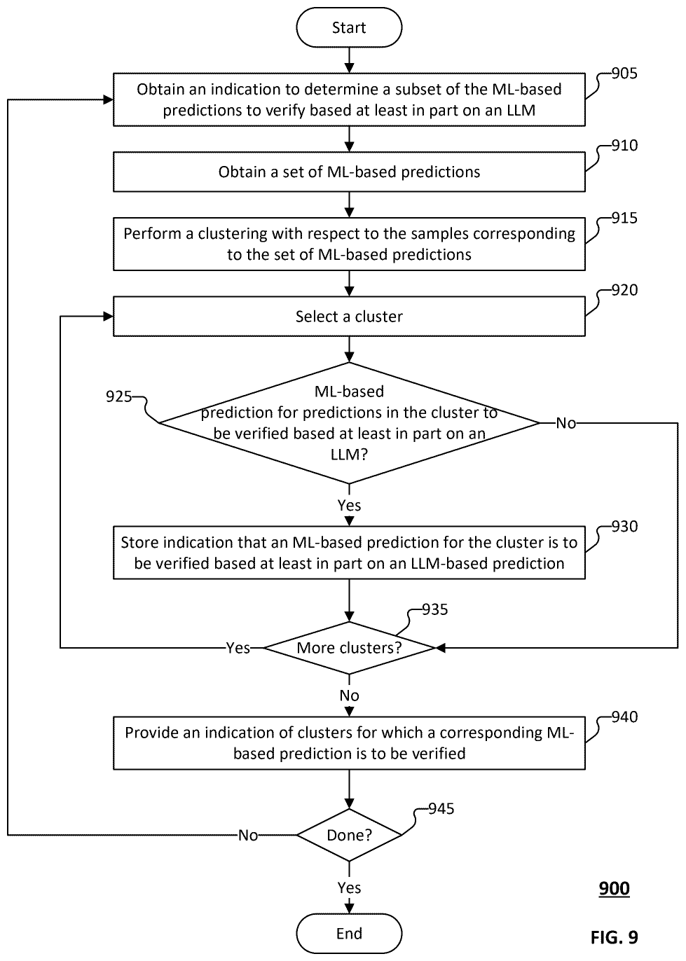

FIG. 9 is a flow diagram of a method for identifying samples for which an LLM is to be used to verify an ML model-based prediction according to various embodiments. In some embodiments, process 900 is implemented at least in part by system 100 of FIG. 1 and/or system 200 of FIG. 2. Process 900 may be implemented by an upstream device such as a worker node, a virtual machine, etc. In some embodiments, process 900 is invoked by 710 of process 700.

At 905, the system obtains an indication to determine a subset of the ML-based predictions to verify based at least in part on an LLM.

At 910, the system obtains a set of ML-based predictions. The set of ML-based predictions comprise a set of inline ML-based predictions that are made inline in connection with evaluating/classifying intercepted samples contemporaneous with mediating the traffic. Additionally, or alternatively, the ML-based set of offline ML-based predictions that are made offline, such as during a classification of a set of samples in a repository periodically or in batches, etc.

At 915, the system performs a clustering with respect to the samples corresponding to the set of ML-based predictions. For example, the system clusters a set of HTTP payloads to group samples having a similar semantic meaning but that may have different representations.

At 920, the system selects a cluster.

At 925, the system determines whether an ML-based prediction for predictions in the cluster is to be verified based at least in part on an LLM. For example, the system selects a representative ML-based prediction that can be evaluated using an LLM or techniques to determine a ground truth and evaluate the correctness of the ML-based prediction. The evaluation or ground truth for the representative ML-based prediction may be used as a proxy for evaluating the classification of each of the samples within the cluster.

In response to determining that the ML-based prediction for the predictions in the cluster, process 900 proceeds to 930 at which, the system stores an indication that an ML-based prediction for the cluster is to be verified based at least in part on an LLM-based prediction. For example, the system queues the cluster for an evaluation of the efficacy of the ML model or to otherwise determine a ground truth for classifying the samples within the cluster. Thereafter, process 900 proceeds to 935. Conversely, in response to determining that the ML-based prediction for predictions in the cluster, process 900 proceeds to 935.

At 935, the system determines whether another cluster(s) is to be evaluated to determine whether to verify the corresponding ML-based predictions. In response to determining that another cluster(s) is to be evaluated, process 900 returns to 920 and process 900 iterates over 920-935 until no further clusters are to be evaluated. In contrast, in response to determining that no further clusters are to be evaluated, process 900 proceeds to 940.

At 940, the system provides an indication of the clusters for which a corresponding ML-based prediction is to be verified (e.g., evaluated for efficacy or compared to classifications using other technique to determine a ground truth sample classification). In some embodiments, the system provides the indication to another process, service, or system that invoked process 900.

At 945, a determination is made as to whether process 900 is complete. In some embodiments, process 900 is determined to be complete in response to a determination that no further samples are to be classified, no further clusters are to be evaluated, no further ML-models are to be evaluated, an administrator indicates that process 900 is to be paused or stopped, etc. In response to a determination that process 900 is complete, process 900 ends. In response to a determination that process 900 is not complete, process 900 returns to 905.

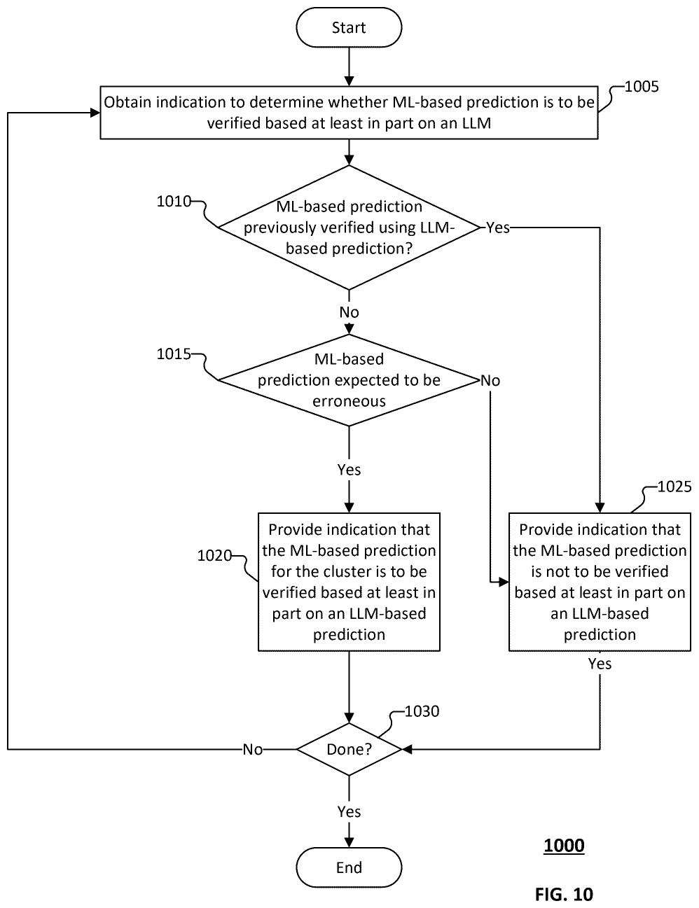

FIG. 10 is a flow diagram of a method for verifying an ML model-based prediction according to various embodiments. In some embodiments, process 1000 is implemented at least in part by system 100 of FIG. 1 and/or system 200 of FIG. 2. Process 1000 may be implemented by an upstream device such as a worker node, a virtual machine, etc. In some embodiments, another system or service invokes process 1000 in response to receiving, at 945, an indication at that a ML-based prediction for a cluster is to be evaluated.

At 1005, the system obtains an indication to determine whether ML-based prediction is to be verified based at least in part on an LLM.

At 1010, the system determines whether the ML-based prediction was previously verified using an LLM-based prediction.

In response to determining that the ML-based prediction was previously verified using the LLM-based prediction, process 1000 proceeds to 1025 at which the system provides an indication that the ML-based prediction is not to be verified based at least in part on an LLM-based prediction.

In response to determining that the ML-based prediction has not been previously verified using the LLM-based prediction, process 1000 proceeds to 1015 at which the system determines whether the ML-based prediction is expected to be erroneous. For example, because querying an LLM can be costly (e.g., in the expense for the compute resources to query the LLM or the latency introduced by such a query), the system can filter the ML-based predictions (e.g., ML-based prediction for a particular sample, or a representative ML-based prediction for a cluster of samples) before verifying an ML-based prediction. In some embodiments, the system can prefilter the ML-predictions for which an LLM is queried to establish a ground truth based on one or more predefined heuristics, rules, or other classifiers. The system can use one or more heuristic to validate/verify the ML-based prediction. For example, the system can use a set of heuristics or other classifiers. If the sample is deemed to be benign or has no other threat indicators based on the classifications using the set of heuristics of

In some embodiments, the system first validates the ML-based prediction that a sample is malicious using a predefined heuristic(s), and if the heuristic(s) indicates that the ML-based prediction is incorrect (or if the sample classification based on the heuristic(s) is different from the ML-based prediction), the system uses the particular ML-based prediction as a candidate for LLM-based verification. For example, the system can deem the sample to be benign or non-malicious based on the predefined heuristic.

In some embodiments, the system first validates the ML-based prediction that a sample is non-malicious using a predefined heuristic(s), and if the heuristic(s) indicates that the ML-based prediction is incorrect (or if the sample classification based on the heuristic(s) is different from the ML-based prediction), the system uses the particular ML-based prediction as a candidate for LLM-based verification. For example, the system can deem the sample to be benign or non-malicious based on the predefined heuristic.

In some embodiments, the ML-based prediction is expected to be erroneous if a predefined number of threat indicators are indicative of a sample classification different from the ML-based predicted sample classification. The predefined number of threat indicators may be configurable, such as to adjust the sensitivity of the system to either invoke a verification based on an LLM-based prediction more or less frequently. The threat indicators may be associated with sample classifications based on a set of heuristics, a set of other classifiers (e.g., classifiers using different ML models or different classification techniques), etc.

In response to determining that the ML-based prediction is not expected to be erroneous, process 1000 proceeds to 1025. Conversely, if the ML-prediction is expected to be erroneous, process 1000 proceeds to 1020 at which the system provides an indication that the ML-based prediction for the cluster is to be verified based at least in part on an LLM-based prediction. In some embodiments, the system provides the indication to another process, service, or system that invoked process 1000.

At 1030, a determination is made as to whether process 1000 is complete. In some embodiments, process 1000 is determined to be complete in response to a determination that no further samples are to be classified, no further ML-models are to be evaluated, an administrator indicates that process 1000 is to be paused or stopped, etc. In response to a determination that process 1000 is complete, process 1000 ends. In response to a determination that process 1000 is not complete, process 1000 returns to 1005.

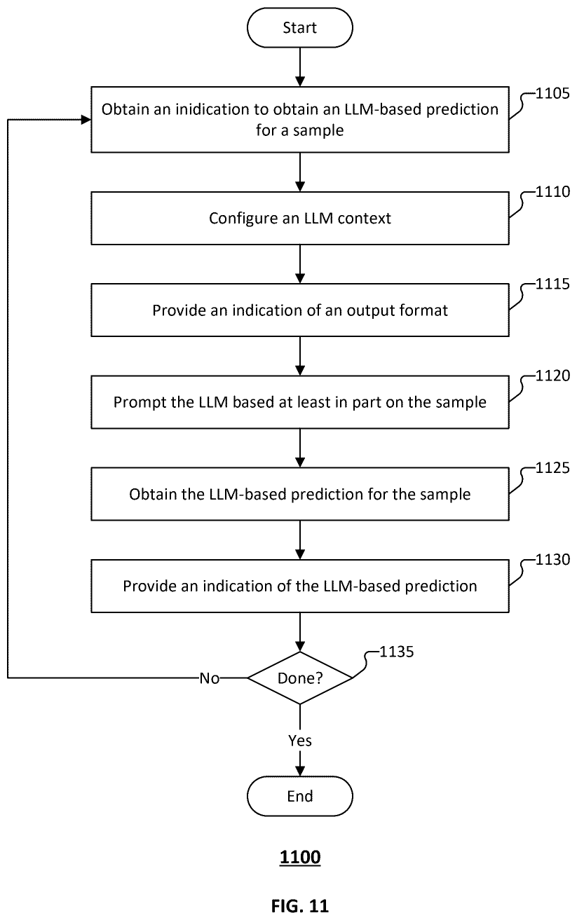

FIG. 11 is a flow diagram of a method for obtaining an LLM-based prediction according to various embodiments. In some embodiments, process 1100 is implemented at least in part by system 100 of FIG. 1 and/or system 200 of FIG. 2. Process 1100 may be implemented by an upstream device such as a worker node, a virtual machine, etc.

At 1105, the system obtains an indication to obtain an LLM-based prediction for a sample. In some embodiments, the system obtains the indication based on 1020 of process 1000.

At 1110, the system configures the LLM context. In some embodiments, configuring the LLM context includes invoking process 1200. The system can configure the context of the LLM based on a set of instructions that indicate what is being asked of the LLM (e.g., to classify a sample), a set of examples of malware and/or goodware, and a set of hints to guide the LLM in proper sample classification, such as to deobfuscate the original presentation of the samples (e.g., by looking beyond the syntax, etc.). The set of instructions may include a sample input and a sample output used to define how the LLM is to behave. The system can include the set of examples of malware and/or goodware to teach the LLM basic vulnerabilities, including vulnerabilities that are seen in the real-world against a set of detections by a security service (e.g., inline detections against intercepted network traffic).

In some embodiments, the system curates the set of malware and/or goodware to include a set of relevant samples. For example, if the sample to be classified is a particular file type or is suspected to be of a particular exploit family, the system can select the set of malware and/or goodware for such types of samples or exploits. As another example, the system curates the set of malware and/or goodware to have a broad set of relevant classifications that cover a wide set of vulnerabilities or exploits, and/or samples that could be mistaken to be an exploit but are in fact benign, etc.

At 1115, the system provides an indication of an output format. The system instructs the LLM to provide the sample classification in a particular output format so that the obtaining the LLM-based prediction can be inserted into a pipeline to obtain LLM-predictions at scale. In some embodiments, the system instructs the LLM to provide the output (e.g., the LLM-based prediction) in JavaScript Object Notation (JSON) format. The system instructs the LLM to provide as part of the output the verdict (e.g., the LLM-based prediction such as whether the sample is benign or malicious), maliciousness proof (e.g., in the case that the sample is deemed malicious,), and the reason for the sample classification. The maliciousness proof may include a snippet of the sample that is indicative of the sample being malicious.

At 1120, the system prompts the LLM based at least in part on the sample.

At 1125, the system obtains the LLM-based prediction for the sample. For example, the system receives the LLM-based predicted sample classification indicating whether the sample is malicious or non-malicious/benign.

At 1130, the system provides an indication of the LLM-based prediction. In some embodiments, the system provides the indication to another process, service, or system that invoked process 1100.

At 1135, a determination is made as to whether process 1100 is complete. In some embodiments, process 1100 is determined to be complete in response to a determination that no further samples are to be classified, no further clusters are to be evaluated, no further ML-models are to be evaluated, an administrator indicates that process 1100 is to be paused or stopped, etc. In response to a determination that process 1100 is complete, process 1100 ends. In response to a determination that process 1100 is not complete, process 1100 returns to 1105.

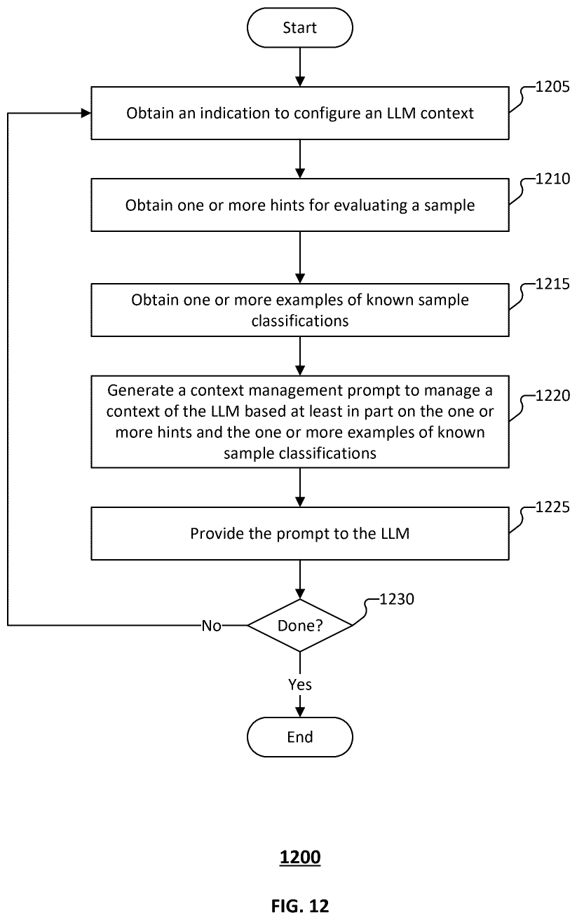

FIG. 12 is a flow diagram of a method for configuring an LLM context according to various embodiments. In some embodiments, process 1200 is implemented at least in part by system 100 of FIG. 1 and/or system 200 of FIG. 2. Process 1200 may be implemented by an upstream device such as a worker node, a virtual machine, etc.

In some embodiments, the system configures the LLM context in connection with teachings the LLM to label malicious detections (e.g., ML-based predictions that indicate a sample is malicious) as either true positive or false positives, and/or label benign predictions as either true negatives or false negatives.

At 1205, the system obtains an indication to configure an LLM context. In some embodiments, the system obtains the indication based on 1110 of process 1100.

At 1210, the system obtains one or more hints for evaluating a sample. In some embodiments, the system uses a predefined set of hints that are applied to all LLM-based predictions, and the set of hints can be updated based on new detections or samples for which the ML-based prediction or the LLM-based prediction was different from the corresponding ground truth. In some embodiments, the system can curate/select the one or more hint based on type of sample, such as type of file or sample family, type of expected exploit, etc. The system can use the one or more hints in connection with teaching the LLM to ignore certain samples or characteristics/patterns of the samples that were previously indicated as being erroneously predicted, and to ignore future such characteristics/patterns of the samples in the future (e.g., do not use the characteristics/patterns of the samples in a manner that would perpetuate the erroneous classification).

At 1215, the system obtains one or more example of known sample classifications. The set of known sample classifications can include a set of classifications for malware and/or goodware. In some embodiments, the one or more known sample classifications provided to the LLM to configure the context are predefined such as in the case that the examples are to be broadly applied for all/most LLM sample classifications. In some embodiments, the system curates or selects the set of known sample classification used to configure the LLM context. For example, the set of known sample classification can be selected based on type of sample, such as type of file or sample family, type of expected exploit, etc.

In some embodiments, the system can incorporate erroneous LLM-predictions as a feedback for re-teaching the LLM. For example, the system can identify those samples or particular characteristics/patterns of the samples that the LLM erroneously classified and reincorporate such samples into the example set for teaching the LLM or configuring the LLM context. Traditional off-the-shelf LLMs that are pre-trained are found to provide inconsistent sample classifications and can often detect evasive aspects of some samples while being confused by relatively simple attacks/exploits. The use of the erroneous LLM-predictions as a feedback to re-teach the LLM further refines the accuracy of the LLM-based predictions and the scope of exploits that the LLM can detect.

At 1210, the system generates a context management prompt to manage (e.g., set or define) a context of the LLM based at least in part on the one or more hints and the one or more examples of known classifications.

At 1225, the system provides the prompt to the LLM. For example, the system prompts the LLM with the context management prompt to configure the LLM context. The LLM context can be configured to teach the LLM how to behave with respect to the sample classification (e.g., to define the LLM context under which the LLM is to classify a sample).

At 1230, a determination is made as to whether process 1200 is complete. In some embodiments, process 1200 is determined to be complete in response to a determination that no further samples are to be classified, no further clusters are to be evaluated, no further ML-models are to be evaluated, an administrator indicates that process 1200 is to be paused or stopped, etc. In response to a determination that process 1200 is complete, process 1200 ends. In response to a determination that process 1200 is not complete, process 1200 returns to 1205.

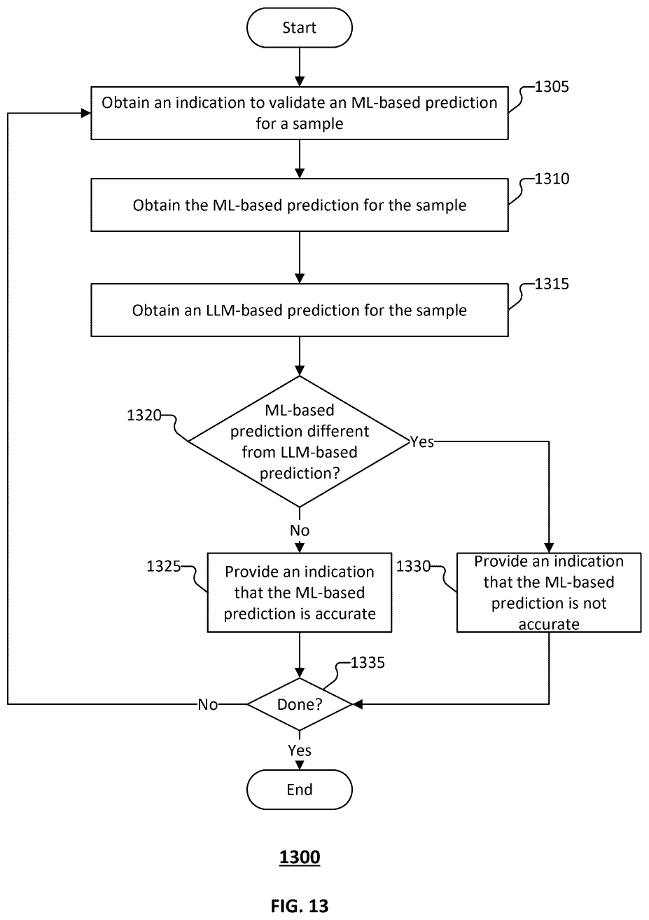

FIG. 13 is a flow diagram of a method for verifying an ML model-based prediction according to various embodiments. In some embodiments, process 1300 is implemented at least in part by system 100 of FIG. 1 and/or system 200 of FIG. 2. Process 1300 may be implemented by an upstream device such as a worker node, a virtual machine, etc.

At 1305, the system obtains an indication to validate an ML-based prediction for a sample. At 1310, the system obtains the ML-based prediction for the sample. At 1315, the system obtains an LLM-based prediction for the sample. For example, the system queries/prompts the LLM for a sample classification (e.g., after the LLM context has been configured). At 1320, the system determines whether the ML-based prediction is different from the LLM-based prediction. In response to determining that the ML-based prediction is not different from the LLM-based prediction, process 1300 proceeds to 1325 at which the system provides an indication that the ML-based prediction is accurate. In some embodiments, the system provides the indication to another process, service, or system that invoked process 1300. In contrast, in response to determining that the ML-based prediction is different from the LLM-based prediction, process 1300 proceeds to 1330 at which the system provides an indication that the ML-based prediction is not accurate. In some embodiments, the system can perform a post-filtering of the sample classifications before providing the indications at 1325 or 1330, such as to confirm or verify the ground truth established by the LLM-based validation. In some embodiments, the system provides the indication to another process, service, or system that invoked process 1300.

At 1335, a determination is made as to whether process 1300 is complete. In some embodiments, process 1300 is determined to be complete in response to a determination that no further probing timers are to be updated, no further application servers are deemed unavailable, an administrator indicates that process 1300 is to be paused or stopped, etc. In response to a determination that process 1300 is complete, process 1300 ends. In response to a determination that process 1300 is not complete, process 1300 returns to 1305.

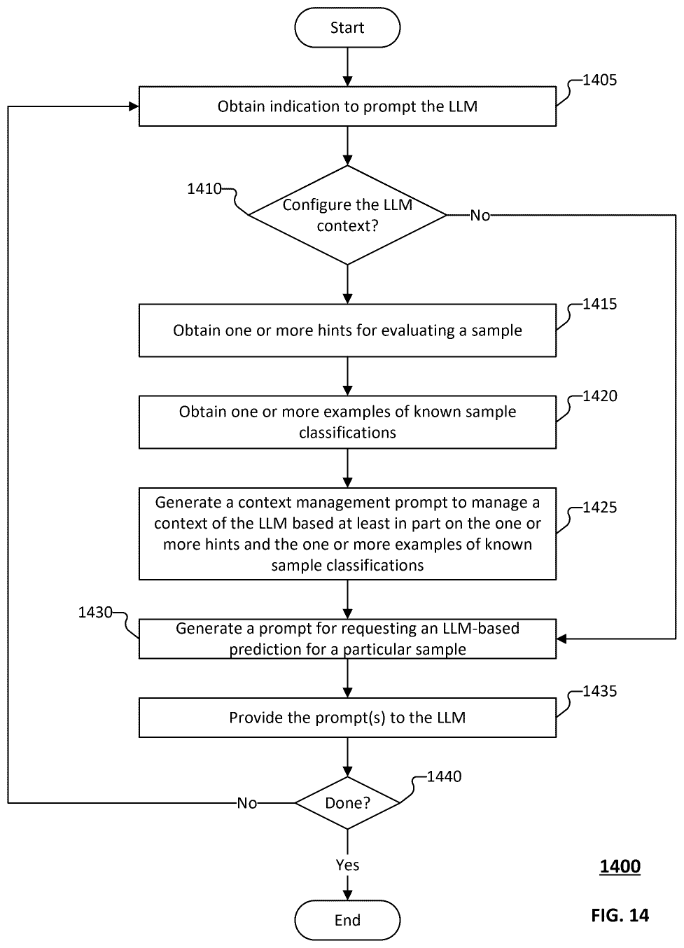

FIG. 14 is a flow diagram of a method for determining a prompt to obtain an LLM-based prediction according to various embodiments. In some embodiments, process 1400 is implemented at least in part by system 100 of FIG. 1 and/or system 200 of FIG. 2. Process 1400 may be implemented by an upstream device such as a worker node, a virtual machine, etc.

At 1405, the system obtains an indication to prompt the LLM. For example, the system obtains an indication that an LLM-based prediction is to be obtained for a particular sample or set of samples. The system may obtain the indication in connection with determining that a new session for querying the LLM for sample classifications is to be started. During that particular session, the system can query the LLM for sample classifications for a set of samples.

At 1410, the system determines whether to configure the LLM context. For example, the system determines whether the LLM context has already been configured. The system may prompt the LLM for LLM-based predictions for sample classifications for a plurality of sample and can provide such prompts during a single session. In this manner, the LLM context can be configured and then the LLM can be prompted for a plurality of LLM-based predictions. In response to determining that the LLM context is not to be configured, process 1400 proceeds to 1430. Conversely, in response to determining that the LLM context is to be configured, process 1400 proceeds to 1415.

At 1415, the system obtains one or more hints for evaluating a sample. In some embodiments, 1415 is the same as, or similar to, 1210 of process 1200.

At 1420, the system obtains one or more examples of known sample classifications. In some embodiments, 1420 is the same as, or similar to, 1215 of process 1200.

At 1425, the system generates a context management prompt to manage a context of the LLM based at least in part on the one or more hints and the one or more examples of known sample classifications. In some embodiments, 1425 is the same as, or similar to, 1220 of process 1200.

At 1430, the system generates a prompt for requesting an LLM-based prediction for a particular sample.

At 1435, the system provides the prompt(s) to the LLM. In some embodiments, the system prompts the LLM based on the context management prompt and/or a plurality of sample prompts. As an example, the system first prompts the LLM with the context management prompt to configure the context of the LLM and to teach the LLM regarding parameters and hints for providing a sample classification. After the LLM context has been configured, the system prompts the LLM for sample classifications, such as by prompting the LLM with the sample(s) to be classified. As another example, the system can combine the context management prompt and one or more prompts for sample classifications (e.g., prompts comprising the sample) into a single prompt that is then provided to the LLM.

At 1440, a determination is made as to whether process 1400 is complete. In some embodiments, process 1400 is determined to be complete in response to a determination that no further samples are to be classified, no further clusters are to be evaluated, no further ML-models are to be evaluated, an administrator indicates that process 1400 is to be paused or stopped, etc. In response to a determination that process 1400 is complete, process 1400 ends. In response to a determination that process 1400 is not complete, process 1400 returns to 1405.

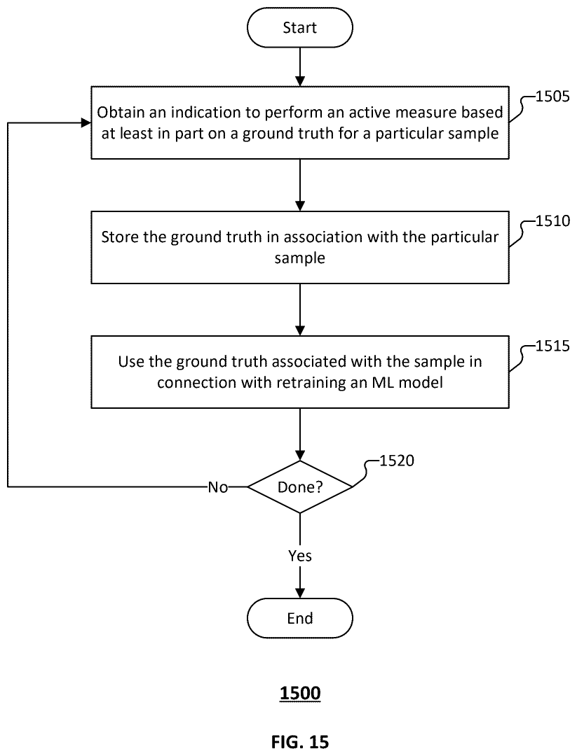

FIG. 15 is a flow diagram of a method for using the ground truth for a sample classification to update an ML model according to various embodiments. In some embodiments, process 1500 is implemented at least in part by system 100 of FIG. 1 and/or system 200 of FIG. 2. Process 1500 may be implemented by an upstream device such as a worker node, a virtual machine, etc. In some embodiments, process 1500 is invoked in response to the system determining that a ground truth for the sample classification of a sample is different from the ML-based prediction for the sample (e.g., in response to determining that the ML model erroneously classified the sample).

At 1505, the system obtains an indication to perform an active measure based at least in part on a ground truth for a particular sample. In some embodiments, the system obtains indication to perform an active measure in response to determining that the ML-based prediction for the particular sample is erroneous. At 1510, the system stores the ground truth in association with the particular sample. In some embodiments, the system stores the particular sample as labeled data. At 1515, the system uses the ground truth associated with the sample in connection with retraining an ML-model. At 1520, a determination is made as to whether process 1500 is complete. In some embodiments, process 1500 is determined to be complete in response to a determination that no further samples are to be classified, no further clusters are to be evaluated, no further ML-models are to be evaluated, an administrator indicates that process 900 is to be paused or stopped, etc. In response to a determination that process 1500 is complete, process 1500 ends. In response to a determination that process 1500 is not complete, process 1500 returns to 1505.

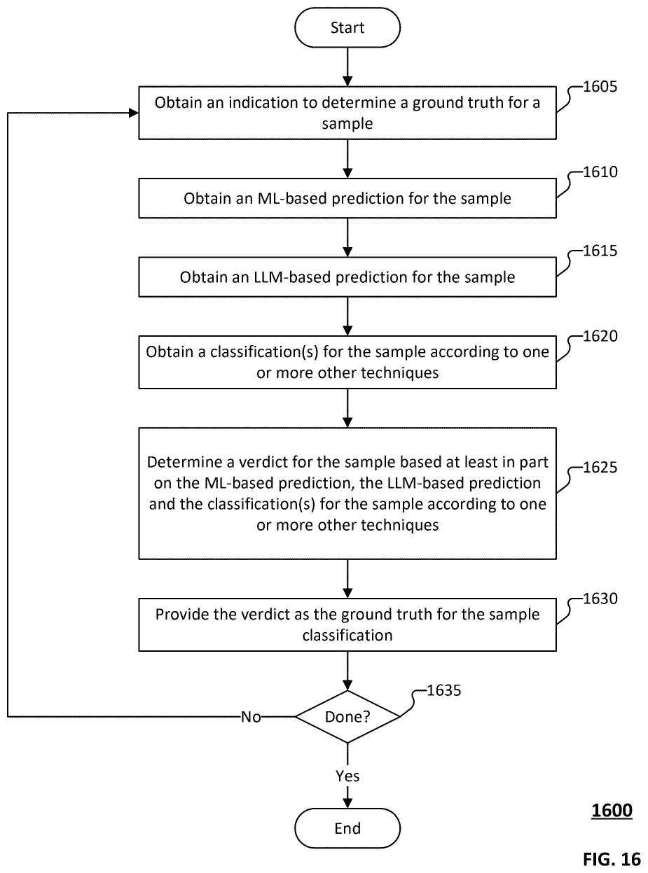

FIG. 16 is a flow diagram of a method for determining ground truth for a sample classification according to various embodiments. In some embodiments, process 1600 is implemented at least in part by system 100 of FIG. 1 and/or system 200 of FIG. 2. Process 1600 may be implemented by an upstream device such as a worker node, a virtual machine, etc. In some embodiments, process 1600 is invoked by 710 of process 700, 940 of process 900, and/or 1010 or process 1000.

At 1605, the system obtains an indication to determine a ground truth for a sample. At 1610, the system obtains an ML-based prediction for the sample. At 1615, the system obtains an LLM-based prediction for the sample. At 1620, the system obtains a classification(s) for the sample according to one or more other techniques. For example, the system can obtain sample classification using one or more other/different ML models, one or more heuristics or rules, one or more other types of classifiers (e.g., a classifier that implements YARA rules), etc. At 1625, the system determines a verdict for the sample based at least in part on the ML-based prediction. In some embodiments, the system determines whether the ML-based prediction is erroneous based on the LLM-based prediction and the one or more other techniques. As an example, the system can determine the verdict (e.g., the ground truth sample classification) based on a determination that a majority of the sample classifications (e.g., the various classifications using the ML model, the LLM, and the one or more other techniques such as other ML models, classifiers, heuristics, etc.) has a verdict that is different from the ML-based prediction. As an example, the system can determine the verdict (e.g., the ground truth sample classification) based on a determination that the LLM-based prediction and the verdict from at least one other technique is different from the ML-based prediction. As another example, the system determines the ML-based prediction erroneously classified a sample as malicious if a number of threat indicators from the LLM and the one or more other techniques (e.g., the number of classifications among the LLM and the one or more other techniques indicating the sample is malicious) is less than a predefined threat indicator threshold. As another example, the system determines the ML-based prediction erroneously classified a sample as benign if a number of threat indicators from the LLM and the one or more other techniques (e.g., the number of classifications among the LLM and the one or more other techniques indicating the sample is malicious) is more than a predefined threat indicator threshold. In some embodiments, the system can resolve a conflict between an ML-based prediction and the LLM-based prediction based on a set of one or more other rules that the threat intelligence based on other information (e.g., information collected by a security service or from third party services). At 1630, the system provides the verdict as the ground truth for the sample. In some embodiments, the system provides the indication to another process, service, or system that invoked process 1600. At 1635, a determination is made as to whether process 1600 is complete. In some embodiments, process 1600 is determined to be complete in response to a determination that no further probing timers are to be updated, no further application servers are deemed unavailable, an administrator indicates that process 1600 is to be paused or stopped, etc. In response to a determination that process 1600 is complete, process 1600 ends. In response to a determination that process 1600 is not complete, process 1600 returns to 1605.

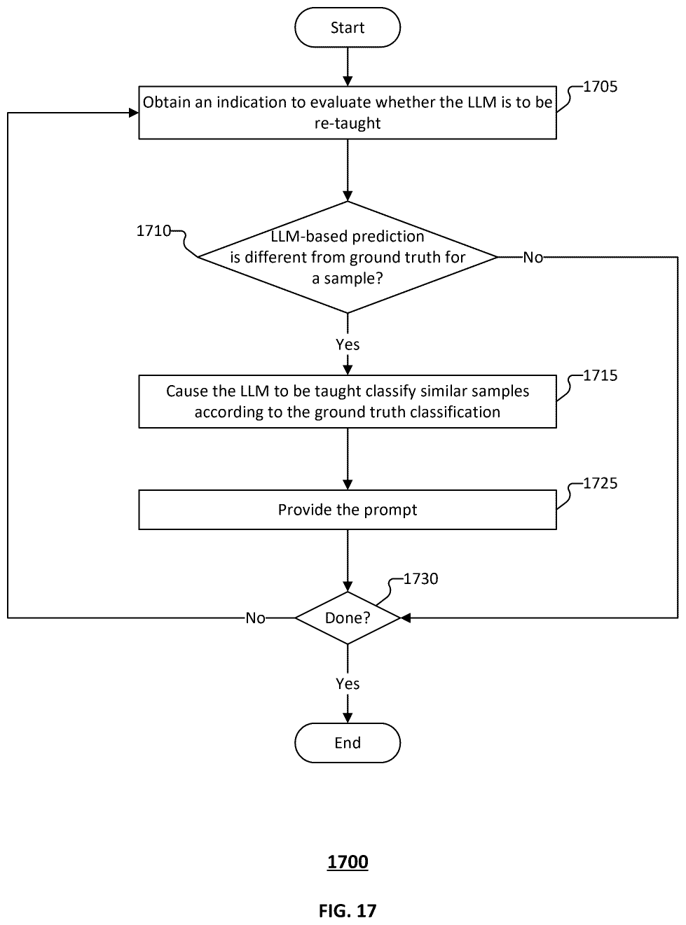

FIG. 17 is a flow diagram of a method for causing the LLM to be retaught according to various embodiments. In some embodiments, process 1700 is implemented at least in part by system 100 of FIG. 1 and/or system 200 of FIG. 2. Process 1700 may be implemented by an upstream device such as a worker node, a virtual machine, etc.

At 1705, the system obtains an indication to evaluate whether the LLM is to be re-taught. For example, the system determines to re-teach the LLM if the LLM erroneously classifies a sample. As another example, the system determines to re-teach the LLM if the LLM erroneously classifies a threshold number of samples. As another example, the system periodically re-teaches the LLM based on a set of historical/previous LLM-predictions.

At 1710, the system determines whether the LLM-based prediction is different from a ground truth for a sample. The ground truth may be determined based on a combination of the ML-based prediction, the LLM-based prediction, and one or more other techniques for classifying the sample (e.g., other ML models, heuristics, rules, classifiers, etc.).

In response to determining that the LLM-based prediction is not different from the ground truth for the sample, process 1700 proceeds to 1730. For example, the system determines that the LLM correctly classified the sample and thus no re-teaching for properly detecting/classifying the sample is needed. Conversely, in response to determining that the LLM-based prediction is different from the ground truth for the sample, process 1700 proceeds to 1715.

At 1715, the system causes the LLM to be taught to classify similar samples according to the ground truth classification. For example, the system stores the ground truth for a sample in association with the sample or a sample family as labeled data. The system can store an indication that the ground truth classification is to be used to re-teach the LLM, such as when the context for the LLM is updated/reconfigured or when the LLM is next prompted to classify a similar sample (e.g., a sample in the same family or that is expected to use a same exploit).

At 1725, the system provides the prompt. For example, the system prompts the LLM with the ground truth classification for the sample as an example classification that the LLM is to use when classifying future samples.

At 1730, a determination is made as to whether process 1700 is complete. In some embodiments, process 1700 is determined to be complete in response to a determination that no further samples are to be classified, no ground truth sample classifications are obtained, no further LLMs are to be re-taught, no further ML models are to be evaluated, an administrator indicates that process 900 is to be paused or stopped, etc. In response to a determination that process 1700 is complete, process 1700 ends. In response to a determination that process 1700 is not complete, process 1700 returns to 1705.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
obtain a machine learning (ML)-based prediction for a security detection; and
prompt a large language model (LLM) for an LLM-based prediction for the security detection based at least in part on a set of examples of malware;
determine a ground truth of the ML-based prediction for the security detection based at least in part on a response from the LLM; and
a memory coupled to the one or more processors and configured to provide the one or more processors with instructions.

2. The system of claim 1, wherein the ML-based prediction for the security detection comprises a prediction of whether a sample is malicious.

3. The system of claim 1, wherein the set of example of malware comprise examples that are observed in traffic across a network.

4. The system of claim 1, wherein a prompt provided to the LLM comprises (i) an indication of a sample input to the LLM, and (ii) an indication of a sample output from the LLM.

5. The system of claim 1, wherein a prompt provided to the LLM comprises a set of hints for deobfuscation of malware.

6. The system of claim 1, wherein determining the ground truth of the ML-based prediction for the security detection with respect to the sample comprises:
comparing the LLM-based prediction and the ML-based prediction; and
verifying the ML-based prediction for the security detection with respect to the sample based on the comparing of the LLM-based prediction and the ML-based prediction.

7. The system of claim 1, wherein the one or more processors are further configured to:
perform an active measure in response to determining that the ML-based prediction for the security detection with respect to the sample is an erroneous classification.

8. The system of claim 7, wherein the active measure comprises fixing the ML model if the LLM detects an erroneous classification.

9. The system of claim 8, wherein fixing the ML model comprises updating labeled data for a sample to use the LLM-based prediction as a verdict of the security detection with respect to the sample, and the labeled data for the sample is used in connection with retraining the ML model.

10. The system of claim 1, wherein a prompt provided to the LLM comprises one or more parameters for an output from the LLM in response to the prompt.

11. The system of claim 1, wherein the prompt indicates that that the LLM is to format an output for the prompt according to a predefined format, and the predefined format includes in indication of whether a sample is malicious, a snippet of the sample that forms a basis for determining that the sample is malicious, and a sentence that provides an explanation of the LLM-based prediction.

12. The system of claim 1, wherein the set of examples of malware include one or more of (a) an example of a remote code execution exploit, (b) an example directory traversal exploit, (c) an example of an SQL injection exploit, and (d) an example of a command injection exploit.

13. The system of claim 1, wherein prompting the LLM for the LLM-based prediction comprises generating a prompt to comprise an LLM context profile for training the LLM.

14. The system of claim 1, wherein:
obtaining the ML-based prediction for the security detection comprises obtaining a set of malware verdicts generated based on an ML-model; and
the one or more processors are further configured to:
perform a clustering of the set of malware verdicts; and
the LLM is prompted based at least in part on a result of the clustering of the set of malware verdicts.

15. The system of claim 1, wherein the ground truth of the ML-based prediction is used in connection with validating the ML model.

16. The system of claim 1, wherein prompting the LLM for the LLM-based prediction comprises:
determining whether the ML-based prediction for the security detection of a particular sample is malicious;
in response to determining that the ML-based prediction for the security detection of a particular sample is malicious,
generate a prompt to provide to the LLM to request the LLM-based prediction; and
provide the prompt to the LLM.

17. The system of claim 1, wherein the LLM is retrained by prompting the LLM with labeled data for samples that the LLM previously incorrectly classified.

18. The system of claim 1, wherein the LLM-based prediction is used to verify the ML-based prediction.

19. The system of claim 1, wherein the ground truth of the ML-based prediction is further based at least in part on one or more predefined heuristics.

20. A method, comprising:
obtaining a machine learning (ML)-based prediction for a security detection;
prompting a large language model (LLM) for an LLM-based prediction for the security detection based at least in part on a set of examples of malware; and
determining a ground truth of the ML-based prediction for the security detection based at least in part on a response from the LLM.

21. A computer program product embodied in a non-transitory computer readable medium and comprising computer instructions for:
obtaining a machine learning (ML)-based prediction for a security detection;
prompting a large language model (LLM) for an LLM-based prediction for the security detection based at least in part on a set of examples of malware; and
determining a ground truth of the ML-based prediction for the security detection based at least in part on a response from the LLM.
